(19) United States
(12) Patent Application Publication
(10) Pub. No.: US 2020/0397194 A1
(43) Pub. Date: Dec. 24, 2020

(54) CONFIGURABLE MEAL KIT PREPARATION AND STORAGE VEHICLE

(71) Applicant: Zume Inc., Mountain View, CA (US)

(72) Inventors: Joshua Gouled GOLDBERG, San Bruno, CA (US); Vaibhav GOEL, Mumbai (IN)

(73) Assignee: Zume Inc., Mountain View, CA (US)

(21) Appl. No.: 16/636,207

(22) PCT Filed: Oct. 18, 2019
(86) PCT No.: PCT/US19/56841

§ 371 Date: Feb. 3, 2020

Related U.S. Application Data
(60) Provisional application No. 62/747,640, filed on Oct. 18, 2018.

(51) Int. Cl. A47J 44/00; G06Q 30/06; G06T 19/00; B25J 9/00; B25J 11/00

(52) U.S. Cl. CPC A47J 44/00; G06Q 30/0635; B25J 11/0045; B25J 9/0084; G06T 19/006

(57) ABSTRACT

Technologies are generally described for preparation and delivery of configurable meal kits with the assistance of an augmented reality (AR) system. Modular food product preparation systems may receive food items and supplies and prepare food products such as configurable meal kits en route such that the food products are prepared by the time the system reaches a delivery destination. Food preparation process steps and timing may be determined based on travel information (e.g., delivery destination, routes, etc.), as well as, food item and food product information. An on-board AR system may provide a user with an augmented vision of the re-configurable preparation and storage environment in the delivery vehicle through a wearable AR device. The user may be provided with information and/or instructions to assist the autonomous or semi-autonomous (robotic) systems in the environment and to control preparation, packaging, and storage of the food products.

### CROSS-REFERENCE TO RELATED APPLICATIONS

This application claims the benefit of U.S. Provisional Patent Application Ser. No. 62/747,640 filed on Oct. 18, 2018. The disclosures of the above-listed provisional applications are hereby incorporated by reference for all purposes.

### BACKGROUND

Unless otherwise indicated herein, the materials described in this section are not prior art to the claims in this application and are not admitted to be prior art by inclusion in this section.

Conventional food supply chains often include a source or initial supplier of raw ingredients for food products for human consumption, such as plant-based or animal-based ingredients. The ingredients are often transported from the source to one or more processing facilities, where the raw ingredients are prepared into food products including one or more intermediate ingredients and eventually prepared into marketable food products intended for direct human consumption. The food products are then often transported from the processing facilities to locations where consumers can select and/or consume the food products, such as homes, grocery stores, restaurants, etc. Food items in a meal kit are normally processed in a plurality of facilities. The processed food items are then concentrated at a packing facility for packing. A lot of time is typically wasted during those processes, and during transit between the various facilities, generally resulting in a degradation of freshness of food items.

### SUMMARY

The present disclosure generally describes configurable meal kit preparation and storage vehicle with the assistance of an augmented reality (AR) system.

According to some examples, a vehicle to prepare food items en route is described. The vehicle may include a container portion configured to provide a re-configurable environment for one or more food preparation and storage equipment with robotic devices to prepare food items en route to a delivery destination; a communication system configured to enable wired or wireless communications with a remote controller system; and an on-board controller communicatively coupled to the communication system and the robotic devices, the on-board controller configured to receive instructions from the remote controller system associated with one or more steps and a timing for a process to prepare the food items based on travel information, food items information, and food product information collected by the remote controller system for the vehicle. The vehicle may also include an augmented reality (AR) device communicatively coupled to the on-board controller. The AR device may be configured to provide an AR view of the re-configurable environment to enable a user to control operations of the robotic devices for the preparation of the food items or to provide instructions to the user associated with the preparation of the food items.

According to other examples, a modular container system for en route food product preparation is described. The container system may include a container suitable to be fitted onto a truck, a railway car, an airplane, or a watercraft, the container configured to provide a re-configurable environment for one or more food preparation and storage equipment with robotic devices to prepare food items en route to a delivery destination; a communication system configured to enable wired or wireless communications with a remote controller system; and an on-board controller communicatively coupled to the communication system and the robotic devices, the on-board controller configured to receive instructions from the remote controller system associated with one or more steps and a timing for a process to prepare the food items based on travel information, food items information, and food product information collected by the remote controller system for the container. The container system may also include an augmented reality (AR) device communicatively coupled to the on-board controller. The AR device may be configured to provide an AR view of the re-configurable environment to enable a user to control operations of the robotic devices for the preparation of the food items or to provide instructions to the user associated with the preparation of the food items.

According to further examples, a method for preparation of food items en route is described. The method may include providing a re-configurable environment for one or more food preparation and storage equipment with robotic devices to prepare food items en route to a delivery destination in a container portion of a vehicle; providing wired or wireless communications with a remote controller system through an on-board communication system; receiving, at an on-board controller communicatively coupled to the on-board communication system, instructions from the remote controller system associated with one or more steps and a timing for a process to prepare the food items based on travel information, food items information, and food product information collected by the remote controller system for the vehicle; and providing an augmented reality (AR) view of the re-configurable environment to enable a user to control operations of the robotic devices for the preparation of the food items or to provide instructions to the user associated with the preparation of the food items through an AR device communicatively coupled to the on-board controller.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 includes a high-level block diagram for an example configurable meal kit preparation and storage vehicle use with the assistance of an AR system;

FIG. 2A includes examples of vehicles which may be used to process and deliver configurable meal kits with the assistance of an AR system;

FIG. 2B includes an isometric exterior view of an example container that may include equipment for processing and delivery of configurable meal kits with the assistance of an AR system;

FIG. 2C includes an isometric interior view of an example container with a right-hand interior side wall cut away showing racks of heating and storage equipment for processing and delivery of configurable meal kits with the assistance of an AR system;

FIG. 2D includes a top plan view of an example container with a right-hand interior side wall cut away showing preparation equipment for processing and delivery of configurable meal kits with the assistance of an AR system;

FIG. 3A includes an isometric exterior view of an example truck with equipment for processing and delivery of configurable meal kits with the assistance of an AR system;

FIG. 3B includes an isometric view of a portion of a cargo area of a truck that may be used to prepare meal kit during delivery with a right-hand interior side wall cut away and including packing and preparation components secured to the side walls and a transfer robot to transfer food items between the various packing and preparation components;

FIG. 3C includes an isometric view of a portion of a cargo area of a truck that may be used to prepare meal kit during delivery with a left-hand interior side wall cut away and including storage components secured to the side walls;

FIG. 3D includes an isometric view of a portion of a cargo area of a truck that may be used to prepare meal kit during delivery with a right-hand interior side wall cut away and including packing, preparation, and storage components secured to the side walls and a user with an AR device to control the various components;

FIG. 4A illustrates an example AR system to display an augmented scene to a user;

FIG. 4B illustrates example AR glasses to display an augmented re-configurable environment for meal kit preparation;

FIG. 4C illustrates an example AR helmet to display an augmented re-configurable environment for meal kit preparation;

FIG. 4D illustrates an example AR headset to display an augmented re-configurable environment for meal kit preparation;

FIG. 5A illustrates a box for packing food items of meal kits;

FIG. 5B illustrates various configurable meal kit packs such as a thermal pack, a vegetable pack, a protein pack, a hot food pack, a carbohydrate pack, and a seasoning pack;

FIG. 6 illustrates a computing device, which may be used to manage an example system for packing, preparation, and storage of configurable meal kits; and

FIG. 7 includes a flow diagram for a process to prepare and deliver configurable meal kits with the assistance of an AR system;

at least some of which are arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, and/or devices related to configurable meal kit preparation and storage vehicle with the assistance of an augmented reality (AR) system.

Briefly stated, technologies are generally described preparation and delivery of configurable meal kits with the assistance of an augmented reality (AR) system. Modular food product preparation systems may receive food items and supplies and prepare food products such as configurable meal kits en route such that the food products are prepared by the time the system reaches a delivery destination. Food preparation process steps and timing may be determined based on travel information (e.g., delivery destination, routes, etc.), as well as, food item and food product information. An on-board AR system may provide a user with an augmented vision of the re-configurable preparation and storage environment in the delivery vehicle through a wearable AR device. The user may be provided with information and/or instructions to assist the autonomous or semi-autonomous (robotic) systems in the environment and to control preparation, packaging, and storage of the food products.

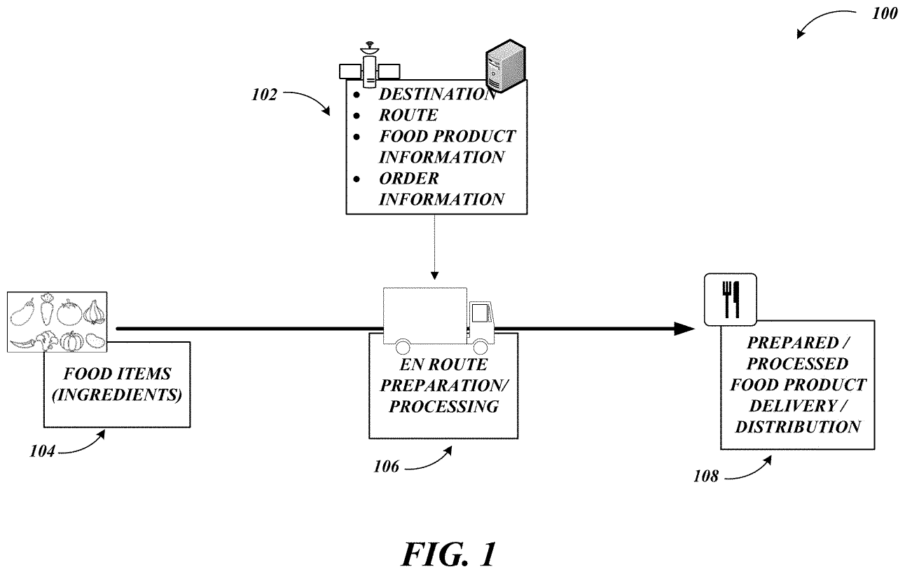

FIG. 1 includes a high-level block diagram for an example configurable meal kit preparation and storage vehicle use with the assistance of an AR system, arranged in accordance with at least some embodiments described herein.

As shown in diagram 100, a delivery vehicle equipped for en route preparation may receive food items 104 (raw materials, ingredients, and similar items to be processed) and deliver prepared and/or processed food product 108 to a delivery destination. Food product 108 may include configurable meal kits with food items in raw, cooked, semi-cooked, and other conditions. En route preparation 106 may include a multi-step process, where operational parameters (e.g., temperature for heating or cooling a food item, water pressure for washing a food item, slicing or blending speeds, etc.) and timing of each step may be determined and/or adjusted based on travel route parameters such as road conditions, weather conditions, traffic congestion, expected arrival time, etc. Weather conditions may include one or more temperature, humidity, altitude, winds, wave size, etc. Road conditions may include one or more of road curvatures, road tilt (or expected vehicle tilt), construction, road roughness, etc.

A control system 102 may receive information associated with the food items (their quantity, quality, type, etc.), food product (quantity, quality, type, packaging, etc.), and/or travel information. The control system 102 may determine operational parameters of the process steps and their timing based on the received information and instruct an autonomous food product preparation system in the delivery vehicle to perform the steps of the process based on the operational parameters and timing. The control system 102 may also send instructions for travel to the delivery vehicle (autonomous driving or for vehicle driver). The control system 102 may communicate through a remote controller with the delivery vehicle and its subs-systems. The delivery vehicle may include an on-board controller to manage operations of its sub-systems in coordination with the remote controller.

The autonomous food product preparation system in the delivery vehicle may include one or more food preparation and storage equipment arranged in one or more sealable container modules configured to feed each other. The delivery vehicle may include a truck, a railway car, and/or a watercraft or any other suitable vehicle. Alternatively, the autonomous food product preparation system may be installed in a container, which may be affixable to and transportable by one or more vehicles. In some cases, updated travel information such as addition of a new intermediate waypoint, elimination of an existing intermediate waypoint, change of the delivery destination, change of vehicle type or status, or selection of a different route may be received while en route. In response, operational parameters and timing of the steps of the process for food product preparation may be adjusted such that the food product is in a desired preparation state when the vehicle arrives at the destination. In some examples, the delivery vehicle may include an AR system that allows a user (e.g., a staff member) to use a wearable AR device and be provided with an augmented vision of the re-configurable preparation and storage environment in the delivery vehicle. The user may be provided with information and/or instructions to assist the autonomous or semi-autonomous systems in the environment and control preparation, packaging, and storage of the food products (e.g., configurable meal kits).

In some implementations, the delivery vehicle may be a customized generic vehicle. For example, a generic shipping container may be customized to create a container capable of providing an environment for en route preparation of food products. The container may then be loaded onto or integrated into a vehicle such as a truck, a semi-truck, a railway car, an airplane, or a watercraft. In another example, a cargo area of a truck, a semi-truck, a railway car, or a watercraft may be customized to provide an environment for en route preparation of food products. The customization may include, but is not limited to, one or more intake ports to receive the food items and supplies, where a size or a position of the one or more intake ports may be re-configurable based on a type of the food items and supplies to be received. The customization may also include one or more delivery ports to provide a prepared food product, where a size or a position of the one or more delivery ports may be re-configurable based on a type of the food product to be delivered. The customization may further include one or more re-configurable anchor systems to anchor one or more food preparation and storage equipment, where the one or more re-configurable anchor systems may include a plurality of unitary anchor points or a plurality of separated anchor points along one or more interior walls, frames, or rails within the container/vehicle. The customization may also include one or more re-configurable supply ports to supply the one or more food preparation and storage equipment, display devices on exterior walls to display advertising, branding information, or images of food preparation process from inside the vehicle.

In an example scenario, a meal kit delivery truck may receive ingredients at a food processing plant and receive instructions to deliver different types and amounts of meal kits to a number of destinations. A control system may determine possible travel routes for the delivery truck and suggest a selected route. The route may be selected based on fastest arrival or based on time needed to complete preparation (which may include preparation of the meal kits, par-cooking of some items in the meal kit, and/or fully cooking of other items in the meal kit). An order of delivery destinations may also be selected based on requested delivery time or based on preparation times needed for the different meal kits. For example, a delivery destination that requested meal kits with longest preparation time (e.g., some items requiring cooking) may be placed as the last destination, whereas a delivery destination that requested only meal kits with raw items may be selected as the first destination. Operational parameters and timing such as temperature of the ovens and refrigerators may be adjusted based on changing traffic conditions. A user fitted with an AR device may be provided with an augmented view of the preparation environment indicating (e.g. highlighting) items to be picked and processed for the meal kit and/or providing controls for robotic equipment in the delivery vehicle.

Operating conditions of the process step and/or food preparation equipment may be adjusted based upon the travel information and/or determined operating conditions of the vehicle. For example, the equipment parameters may be decreased, e.g., speed lowered, based upon determined (estimated or measured) travel information or vehicle parameters such as high vehicle sway or vibration. Similarly, process parameters including temperature, process (e.g., rising or cooking) time and or even ingredients may be adjusted based upon a determined environmental change of the travel information (e.g., altitude, temperature, humidity, etc.) change which may require different preparation parameters or even process. In some cases, equipment operational parameters may be dynamically adjusted based on determined (expected, predicted or measured) container or vehicle parameters based on travel information. For example, equipment may be placed in a closed operation status if vehicle parameters exceed some operational requirements (temperature, to reduce spillage, spoilage, equipment malfunction, etc.). In some cases, the selected food preparation equipment may be changed based on determined (expected, predicted or measured) container or vehicle parameters and travel information. For example, a closed system food preparation equipment (e.g., auger, agitator, plunger etc.) may be selected or adjusted for a processing step based on the travel information, as opposed to an open system food preparation equipment like a conveyor, mixer, etc. In some cases, the control system may pause food preparation at a waypoint stop or may increase food preparation or transfer at a waypoint stop (e.g., when the vehicle is being weighed at a weigh station, when the vehicle is being charged/fueled, or at an operator rest stop, etc.). In some cases, if the container temperature is too hot, equipment operations may be paused or adjusted to meet process requirements.

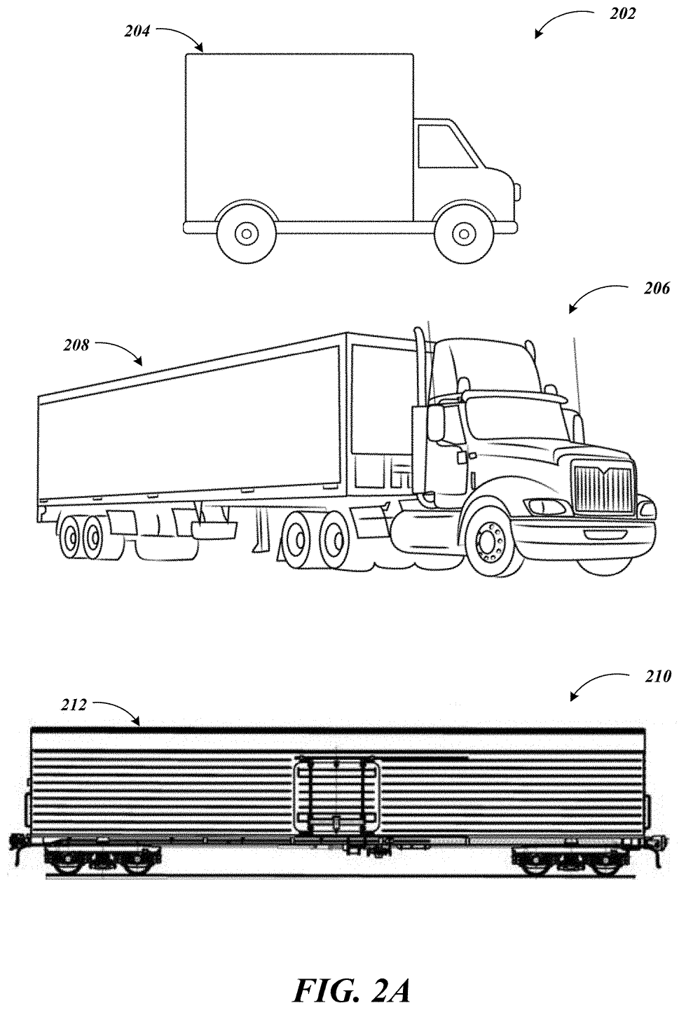

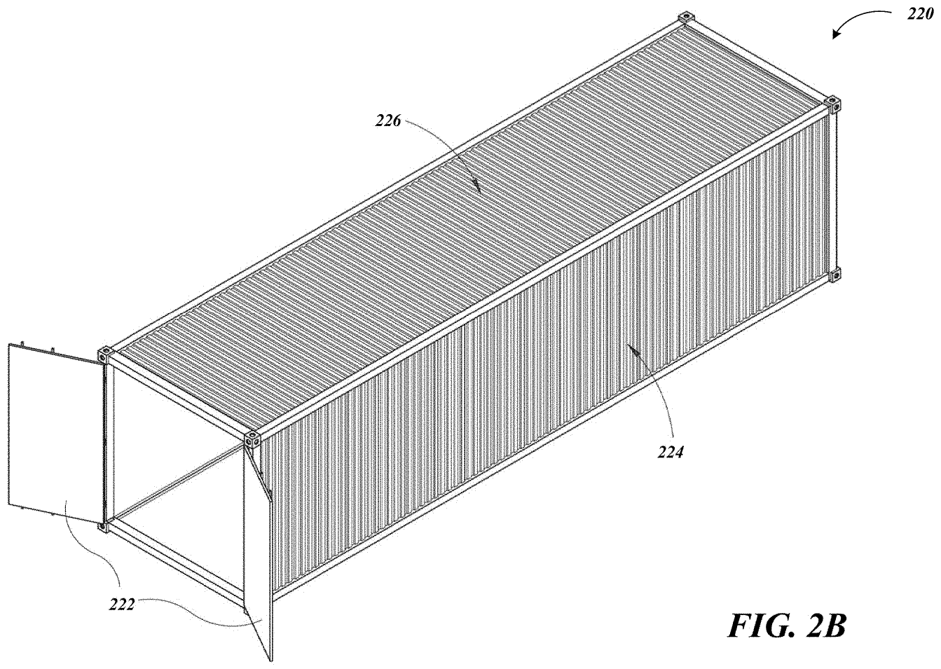

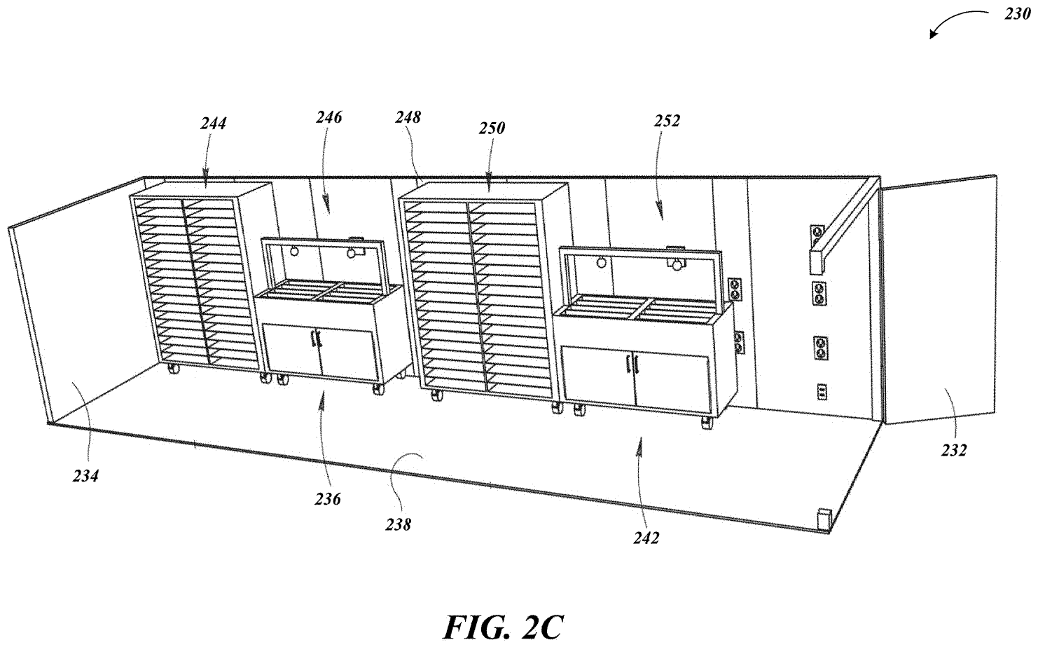

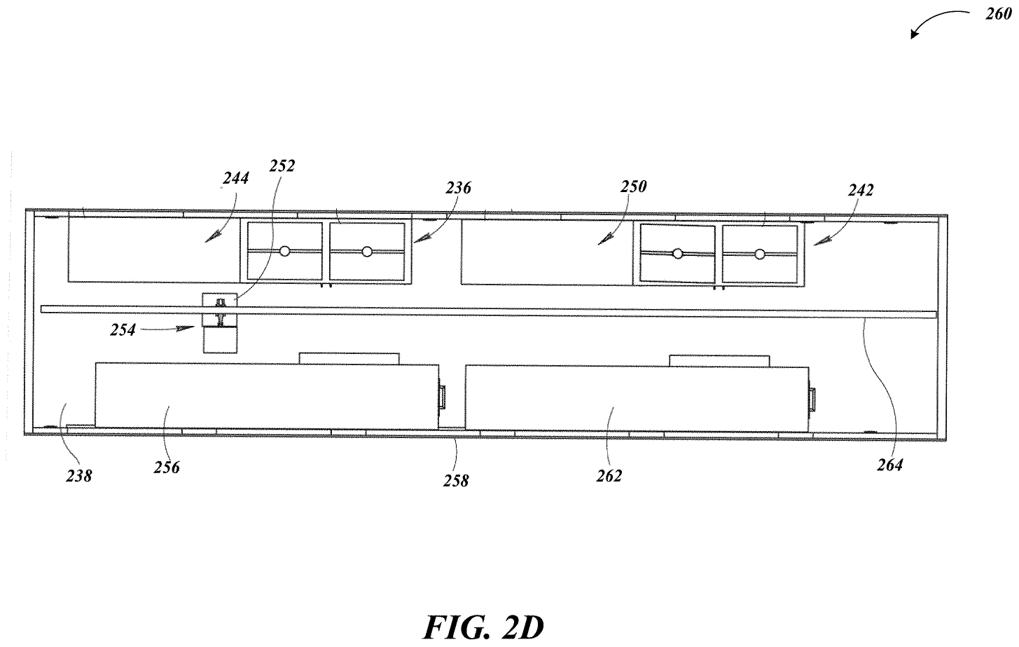

FIG. 2A includes examples of vehicles which may be used to process and deliver configurable meal kits with the assistance of an AR system, arranged in accordance with at least some embodiments described herein.

Preparation, packaging, and storage of food products such as meal kits while en route for delivery may be performed in vehicles such as trucks, vans, railcars, watercraft, or aircraft. In addition to the listed vehicles and similar ones, food products may also be prepared, packaged, and stored in customized containers that may be fitted onto a truck, railcar, watercraft, or airplane. FIG. 2A shows some example vehicles that may be customized to provide an environment for the operations by placement of re-configurable appliances, equipment, and robotic devices for autonomous or semi-autonomous processing.

FIG. 2A includes truck 202, which may have a cargo portion 204 fitted with re-configurable appliances, equipment, and robotic devices for autonomous or semi-autonomous processing. Another example vehicle shown in FIG. 2A includes semi-truck 206 with its trailer 208. The trailer 208 may be a removable cargo container customized to provide an environment for the operations by placement of re-configurable appliances, equipment, and robotic devices for autonomous or semi-autonomous processing. The trailer 208 may also be a permanently affixed cargo portion customized similar to the cargo portion of the truck 202, but with larger space.

FIG. 2A also shows a railcar 210, which may include a cargo portion 212 permanently customized to provide an environment for the operations by placement of re-configurable appliances, equipment, and robotic devices for autonomous or semi-autonomous processing. In some examples, the cargo portion 212 may be a customized container loaded onto railcar 210, which may be a flatbed type railcar.

FIG. 2B includes an isometric exterior view of an example container that may include equipment for processing and delivery of configurable meal kits with the assistance of an AR system, arranged in accordance with at least some embodiments described herein.

FIG. 2B shows a standard intermodal shipping container 220. The container 220 may have same or similar features as corresponding standardized shipping containers in use throughout the world, and dimensions and other characteristics in accordance with corresponding standards for shipping containers. In some implementations, the container 220 may have an external an elongated side face 224, a top face 226, and a front end comprising a pair of doors 222.

In some embodiments, a food preparation container may be dimensioned to slide into and fit inside a shell of the shipping container 220. The food preparation container may include a pair of doors for access to the inside space. The food preparation container may be configured to house autonomous food preparation equipment such that food items may be loaded into the container at a starting station and food products may be completed by the time the food preparation container reaches its destination. The food preparation container may have access ports as discussed above in conjunction with the delivery truck. Thus, in some cases, the dimensions of the food preparation container may be smaller than the shipping container 220 acting as the outer shell.

In some alternative implementations, the shipping container 220 may be configured and dimensioned to slide into and fit inside a semi-truck trailer, loaded onto a flatbed truck, a railway car, a watercraft, or similar vehicles. The food preparation equipment inside the shipping container 220 may be configured in a modular fashion to provide a sterile environment for preparation of food items autonomously. As such, the food preparation container may include suitable control, power, communications, and computing equipment in addition to the food preparation equipment such as transport or processing robots, cooking devices, cooling devices, storage equipment, etc.

FIG. 2C includes an isometric interior view of an example container with a right-hand interior side wall cut away showing racks of heating and storage equipment for processing and delivery of configurable meal kits with the assistance of an AR system, arranged in accordance with at least some embodiments described herein.

FIG. 2C shows an inside configuration of a food preparation container 230 similar to the one in FIG. 2B with example autonomous food preparation equipment. In the example configuration of food preparation container 230, two racks 244, 250 of food preparation equipment are installed within the container 230 against the wall 248 on the floor 238. The two racks 244, 250 may have the same or similar features. The racks 244, 250 may house ovens, grills, coolers, storage drawers, or comparable equipment. Food items and supplies may be delivered into the container through the door 232 or other ports and doors that may be installed at suitable locations in suitable dimensions depending on the equipment configuration and food type(s).

Food preparation container 230 may further include ingredient/topping holders 236, 242. Similar to the racks 244, 250, the ingredient/topping holders 236, 242 may have the same or similar features. Depending on the contents, the ingredient/topping holders 236, 242 may have cooling/heating capability, or keep their contents at ambient temperature. Furthermore, dispensing robots 246, 252 may be arranged over the ingredient/topping holders 236, 242 to select, pick, and dispense contents of the ingredient/topping holders 236, 242 during food product preparation.

While specific types of equipment have been illustrated as being installed in the container 230, any food preparation equipment, such as any of the food preparation equipment described herein or food preparation equipment capable of performing any of the food processing or preparation procedures described herein, may be installed in the container 230. In some cases, the order in which the equipment is installed against the walls, front-to-back along the length of the container 230, may not be important, such as when each piece of food preparation equipment works independently, while in other cases, the order in which the equipment is installed, front-to-back along the length of the container 230, is important, such as when the products produced by one piece of food preparation equipment are used as an input by another piece of food preparation equipment.

Food preparation equipment may also be provided in any number of rows, such as one, two, three, four, or five rows extending along the length of the container 230. As another example, food preparation equipment may be provided in any number of layers, such as one, two, three, four, or five layers stacked vertically on top of one another. In general, the arrangement of the equipment within the interior space of the container 230 may be determined or driven by improvements to the overall efficiency of the food preparation system. In some implementations, the inner surfaces of the walls and doors may be made of various plastics or of stainless steel, brass, aluminum, or other oligodynamic materials. In some examples, container 230 may have no openings other than the door 232, that is, the container 230 may have no other doors, windows, or openings, and the door 232 may be closed to seal, such as hermetically seal, the interior of the container 230 from an external environment. In other implementations, the container 230 may have one or more segmented airlocks to control, allow, or prevent the flow of air between the interior of the container 402 and the external environment, and prevent or contain infestations. In some implementations, the container 402 may include one or more lighting systems, such as internal LED lighting systems, internal high-pressure sodium vapor lamp lighting systems, or skylights or windows to provide natural light to the interior of the container 230. In some cases, the interior of the container 230 may be provided with a combination of LED and natural lighting. In some implementations, mirrors, lenses, and/or other optical elements may be used to focus and/or direct light from its source(s) to location(s) where it is desired.

FIG. 2D includes a top plan view of an example container with a right-hand interior side wall cut away showing preparation equipment for processing and delivery of configurable meal kits with the assistance of an AR system, arranged in accordance with at least some embodiments described herein.

Container 260 in FIG. 2C includes the racks 244, 250 and the ingredient/topping holders 236, 242 as shown in FIG. 2B. In addition, two similarly or differently equipped and functioning appliances 256, 262 may be arranged against the opposing wall 258 and be configured to process or store food products (e.g., meal kits) and/or ingredients. Container 260 may further include a transfer robot 252. The transfer robot 252 may be movable along a frame 264 from one end of the container to another end, as well as, vertically between a floor and a ceiling of the container (or subsets of these dimensions). The transfer robot 252 may include an end effector 254, such as a pizza peel or a set of opposable digits, located proximate the bottom surface of the transfer robot 252. The end effector 254 may be used to transfer food items between the various food preparation and packaging equipment and stations. The end effector 254 may also extendably physically couple to the side wall(s) of the transfer robot 252 via an extendable arm. Such an extendable arm may be used, for example, to extend the end effector 254 into an oven compartment to place or retrieve a food item. In some examples, the transfer robot 252 may move vertically along a vertical post, which itself may be horizontally moved along the frame 264, thus giving the transfer robot two-dimensional movement along the container 260. In addition, the transfer robot 252 may be rotationally moved around the vertical post. An AR system as discussed herein may allow a user to control operations of the transfer robot 252 by indicating items to be moved within the container and providing controls (e.g., through eye-tracking, physical controls on the AR device or elsewhere) to manage the operations of the transfer robot 252.

In some implementations, one or more sensors or imagers (e.g., cameras) may be positioned with a field-of-view that encompasses an interior of the food preparation units (e.g., ovens, refrigerators, combination refrigerator/ovens), or a field-of-view that encompasses an exit of the food preparation units or just downstream of the food preparation units. For example, one or more sensors or imagers (e.g., cameras) may have a field-of-view that encompasses a top of the food items, a bottom of the food items, and/or a side of the food items either in the food preparation units or at the exit of the food preparation units or even downstream of the food preparation units. One or more machine-vision systems may be employed to determine whether the parbaked, or even fully baked, food items (e.g., pizzas) are properly cooked based on images captured by the one or more sensors or imagers (e.g., cameras). The machine-vision system may optionally employ machine-learning, being trained on a set of training data, to recognize when the food product is properly prepared, based on captured images or image data. In some instances, this can be combined with a weight sensor (e.g., strain gauge, load cell) to determine when the item of food product is properly prepared, for example determining when an item is cooked based at least in part on a sensed weight where the desired weight is dependent on sufficient water having been evaporated or cooked off.

A machine-learning system or a machine-vision system may, for example, determine whether a top of the food item is a desired color or colors and/or consistency, for instance determining whether there is too little, too much or an adequate or desired amount of bubbling of melted cheese, too little, too much or an adequate or desired amount of blackening or charring, too little, too much or an adequate or desired amount of curling of a topping (e.g., curling of pepperoni slices), too little, too much or an adequate or desired amount of shrinkage of a topping (e.g., vegetables). The system may, for example, determine whether a bottom of the food item is a desired color or colors, for instance determining whether there is too little, too much or an adequate or desired amount of blackening or charring.

Additionally or alternatively, one or more electronic noses may be distributed at various points to detect scents which may be indicative of a desired property of the food item or prepared food item. For example, one or more electronic noses can detect via scent when cheese bubbles and crust forms. Electronic noses may employ one or more sensors (e.g., MOSFET devices, conducting polymers, polymer composites, or surface acoustic wave (SAW) microelectronic systems (MEMS) to detect compounds, for example volatile compounds). Also for example, one or more sensors or imagers (e.g., cameras) may be positioned with a field-of-view that encompasses a portion of an assembly line just prior to loading the food items in packaging, or transit refrigerators or transit ovens (refrigerators or ovens in which food items are transported in vehicles). The acquired information can be used to assess whether the food item has been correctly prepared, has the correct toppings and a satisfactory distribution (e.g., quantity and spatial distributions), does not contain foreign matter, has been correctly parbaked or evenly cooked. In response to determination that any single characteristic of the food time is unsuitable (e.g., outside a defined threshold or range of values), the food item may be rejected with a replacement order placed.

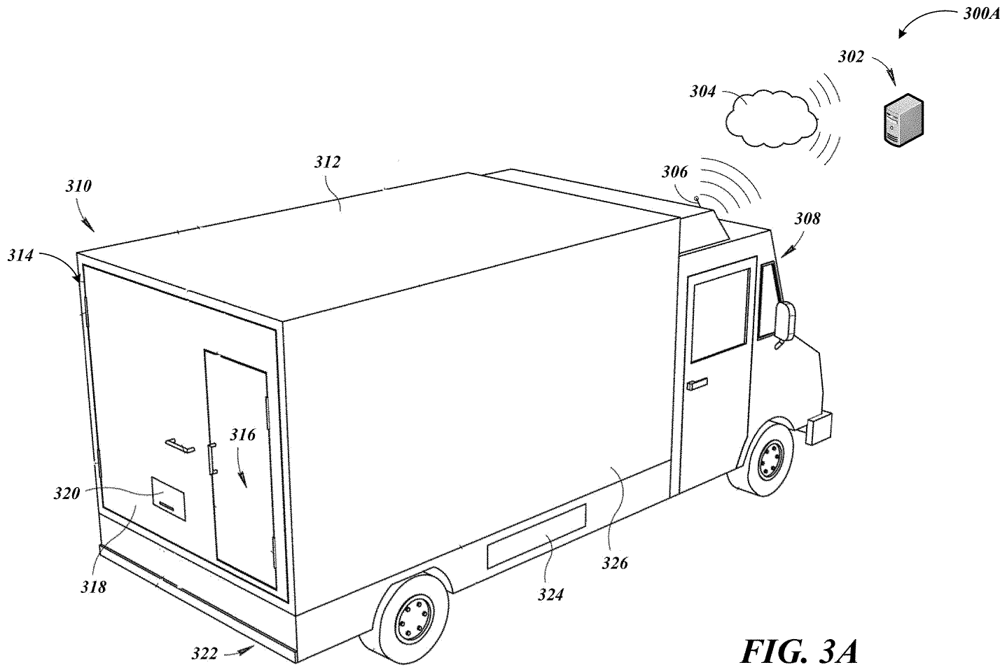

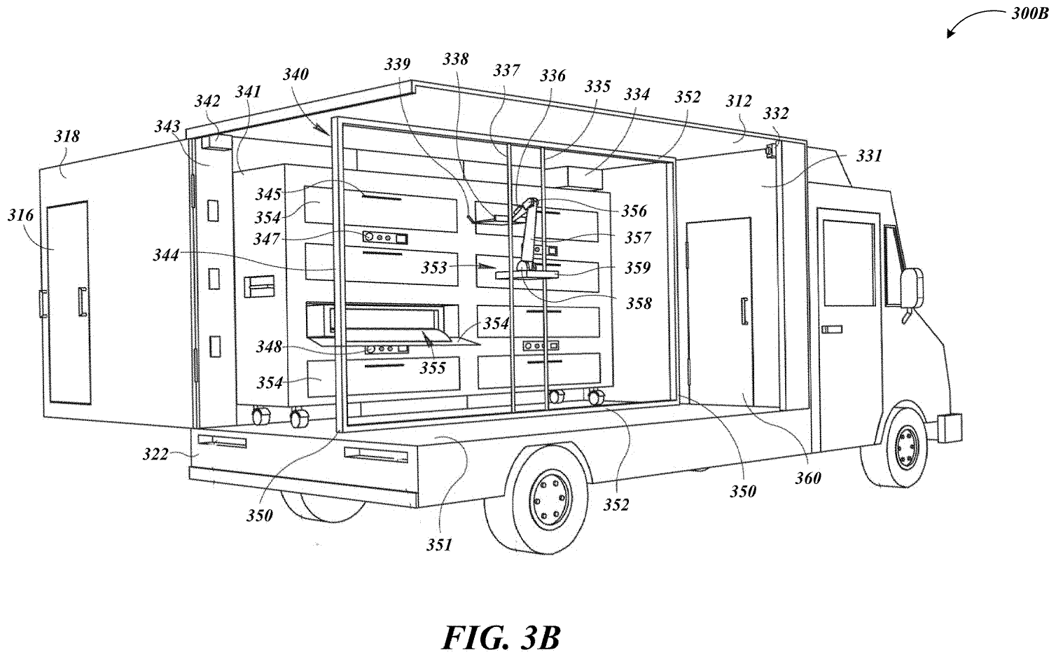

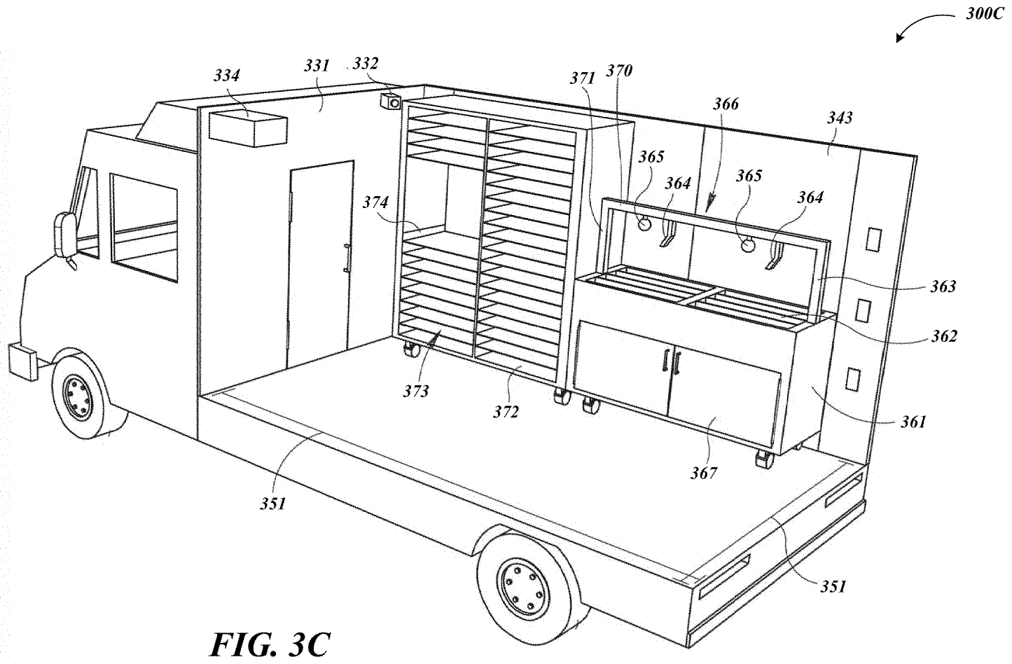

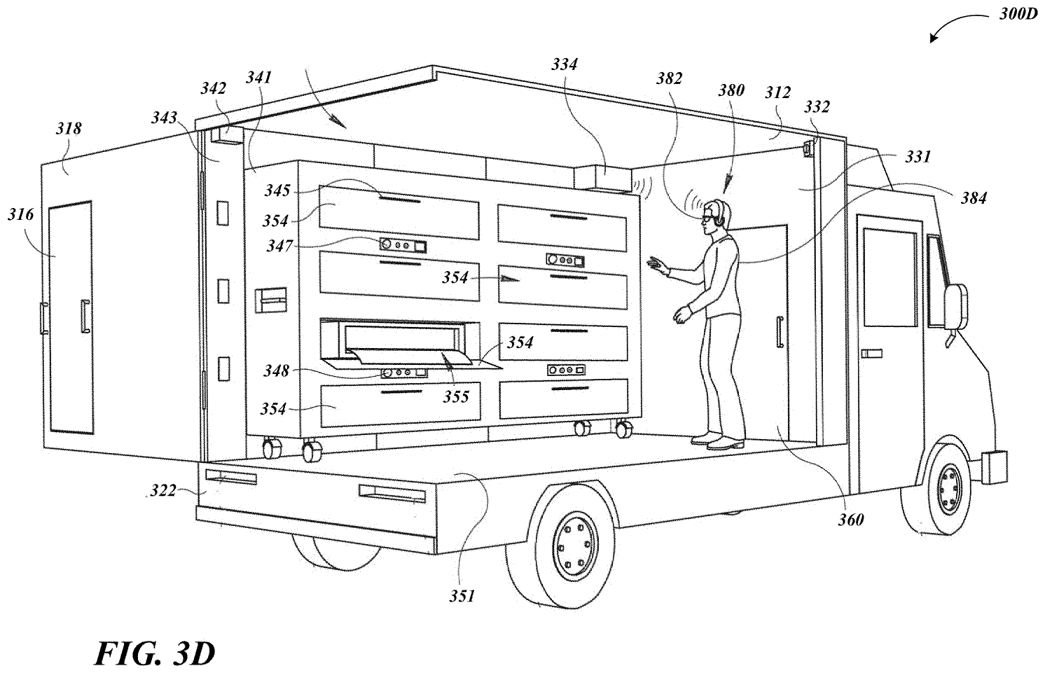

FIG. 3A includes an isometric exterior view of an example truck with equipment for processing and delivery of configurable meal kits with the assistance of an AR system, arranged in accordance with at least some embodiments described herein.

Diagram 300A shows an exterior view of a delivery truck that includes a cab portion 308 and a cargo portion 310, according to at least one illustrated implementation. The delivery truck may further include a wireless communications interface, such as one or more antennas 306 coupled to an internally installed transceiver. The one or more antennas 306 may, for example, be located on or above the roof of the cab portion 308. The antenna(s) 306 may be communicatively coupled to enable communication between components on the delivery truck and a remote control system 302 located remotely from the delivery truck via a communications network 304. The cargo portion 310 may include a top side 312, a left exterior side wall (not shown) and a right exterior side wall 326 (collectively exterior side walls), a back wall 318, and a bottom side 322. The dimensions (width, length, and height) of the cargo portion 310 may be based on local or state ordinances regarding delivery, such as, for example, local or state ordinances governing food delivery vehicles, as well as, delivery environment needs (size of streets, parking spaces), delivered/processed food products, etc.

The back wall 318 may include one or more loading doors 314 that are sized and dimensioned to provide access to a cargo area enclosed within the cargo portion 310 of the delivery truck. In some implementations, the loading door(s) 314 may be a single door that stretches substantially across (i.e., >50%) the width of the back wall 318. In such an implementation, the loading door 314 may include a single set of hinges that may physically and rotationally couple the loading door 314 to the vehicle, or the loading door 314 may comprise multiple doors, such as a set of double doors, that together stretch substantially across (i.e., >50%) the width of the back wall 318. The back wall 318 may also include a personnel door 316 located within the loading door 314. The personnel door 316 may be physically, rotationally coupled to the loading door 314 by a set of one or more hinges. The personnel door 316 may rotate in the same direction or in the opposite direction as the loading door 314 in which the personnel door 316 is located. The dimensions, e.g., width and height, of the personnel door 316 are smaller than the corresponding dimensions of the loading door 314, for example (<33%) of the width along the back wall 318. The personnel door 316 may be set within the loading door 314 relatively closer to one or the other exterior side walls, or the personnel door 316 may be centered within the loading door 314 relative to the exterior side walls. In some implementations, the loading door 314 may include one or more additional small doors 320 that may be smaller than the personnel door 316. The small doors 320 may enable food products to be passed from the cargo portion to a person or customer standing outside of the vehicle.

The cargo portion 310 may be fitted with food preparation equipment to allow preparation and food items manually, semi-autonomously, or fully autonomously while the delivery truck is en route. In some example embodiments, the delivery truck may be used as a delivery hub. For example, the delivery truck may pick up ingredients (food items) at a source and drive to a central location for expected deliveries (e.g., a parking lot, a business, etc.). The food items may be prepared into finished food products such as meal kits (and packaged) ready for delivery by the time the delivery truck arrives at its destination. Once the delivery truck is parked (or in some cases, still en route), completed and packaged food products may be provided to human delivery people, airborne or ground-based drones for delivery to end destinations (e.g., homes, businesses, schools, hospitals, etc.). The delivery drones may be manually controlled by a human who is located locally or remotely from the delivery robot, and/or controlled autonomously, for example using location input or coordinate from an on-board GPS or GLONASS positioning system and receiver for from one or more wireless service provider cellular towers. In some implementations, location input and/or positioning may be provided using on-board telemetry to determine position, vision systems coupled with pre-recorded photos of the surrounding environment, peer-to-peer relative positioning with other autonomous or non-autonomous vehicles, and/or triangulation with signals from other autonomous or non-autonomous vehicles. In some implementations involving multiple delivery drones, the delivery drones may make deliveries during overlapping time periods.

FIG. 3B includes an isometric view of a portion of a cargo area of a truck that may be used to prepare meal kit during delivery with a right-hand interior side wall cut away and including packing and preparation components secured to the side walls and a transfer robot to transfer food items between the various packing and preparation components, arranged in accordance with at least some embodiments described herein.

Diagram 300B shows a cargo area of a delivery vehicle (truck) into which meal kit packing, food preparation, and/or storage equipment and multiple robots have been loaded, according to at least one illustrated implementation. The meal kit packing, food preparation, and/or storage equipment include the rack 341. Although a rack 341 with multiple kitchen appliances 346, 349 is shown in diagram 300B, such disclosure should not be considered limiting. Other cooking components may be loaded and secured into the cargo area. Such cooking components may include, for example, a fryer, a griddle, a sandwich or tortilla press, and other like cooking components. The cargo area may include one or more robots that perform food preparation functions within the cargo area. The robots may include, for example, a transfer robot 353, a dispensing robot, a packaging/boxing robot, a food crushing robot, food chopping robot, food slicing robot, food squeezing robot, food mixing robot, food homogenizing robot, food pressing robot, or the like.

In one embodiment, the robots may perform specific food preparation steps for the food items needed for the meal kit, e.g., crushing garlics, chopping onions, slicing tomatoes, slicing lemons, etc. In one embodiment, the preparation of the food items does not include cooking the prepared food items. For example, crushing the garlic but not cooking it, chopping the onions but not cooking it, slicing the lemons but not cooking it, etc. In a further embodiment, the processed food items may be mixed with other food items, e.g., the crushed garlic is mixed with butter and salt and rubbed on a steak; chopped onion is mixed with other vegetables, etc.

The rack 341 may be securely attached to one or more anchor rails and/or retractable bolts spaced along the interior side wall 343 and oriented such that the kitchen appliances 346, 349 may be accessible from the cargo area. The rack 341 may be coupled to one or more of the power outlets, the water ports, the waste fluid ports, the air ports, and/or the communications ports located along the interior side wall 343. In some implementations, the rack 341 may be loaded into the cargo area with each slot loaded with a corresponding kitchen appliance 346, 349. In such an implementation, each kitchen appliance 346, 349 that is loaded into the rack 341 may further contain a food item to be used in a meal kit. Each kitchen appliance may include a handle 345 located along the door 354. In some implementations, the handle 345 may be used to rotate or otherwise displace the door 354 to selectively expose or cover the opening to the interior compartment 355 of the kitchen appliance 346, 349. The rack 341 and each kitchen appliance within the rack 341 may be communicatively coupled to the on-board control system 334 via the one or more communication ports located along the interior side wall 343. The on-board control system 334 may provide cooking commands that control the heating elements within each of the kitchen appliances 346, 349. Such cooking commands may be generated according to processor-executable instructions executed by one or some combination of the on-board control system 343, the off-board control system 302, or some other remote computer system.

The transfer robot 353 may be used to selectively transfer food items into and out of the kitchen appliances 346, 349. In one implementation, the kitchen appliances are equipped with one or more rotating spirals. Packed or unpacked food item may be loaded in the grooves of the rotating spirals. The rotating spirals may turn clockwise/counter clockwise to transfer food items out of the kitchen appliances 346, 349. In one implementation, the transfer robot 353 may be holding and positioning a box for packing meal kits at an appropriate position such that when the kitchen appliance is transferring the desired food item out. The food item can be delivered into a designated position within the box. Additionally or alternatively, this operation may be performed in cooperation with a packaging or boxing robot (not shown) communicatively coupled to transfer robot 353, on-board control system 343, or both.

The transfer robot 353 may be communicatively coupled to the on-board control system 343, which may provide instructions to control the movement of the transfer robot 353. The transfer robot 353 may include one or more arms 357 and an end tool 338 as an end effector or end of arm tool. One or more actuators 358 may be used to linearly or rotationally move the one or more arms 357 of the transfer robot 353 with respect to the cargo area in response to signals received from the on-board control system 343. The one or more actuators 358 of the transfer robot 353 may be operable to move the end tool 338 with 6 degrees of freedom with respect to the interior side walls, as illustrated, for example, by a coordinate system.

In some implementations, the end tool 338 may include a finger extension 339 that is sized and shaped to approximate the dimensions of a human finger. The finger extension 339 may be used to engage with the handle 345 on the door 354 of each kitchen appliance to thereby open or close the door 354 as necessary to transfer food items into and out of the compartment 355 of the kitchen appliance. For example, to open the door 354 to a kitchen appliance, the transfer robot 353 may position the end tool 338 proximate the door 354 of the kitchen appliance such that the finger extension 339 engages with the top side of the handle 345 to the door 354. The transfer robot 353 may move the finger extension 339 in a downward direction to apply a downward force to the handle 345 to cause the door 354 to rotate downward into an open. To close the door 354 to the kitchen appliance, the transfer robot 353 may move the finger extension 339 to engage with the handle 345 and/or the downward oriented face of the door 354. The transfer robot 353 may move the finger extension 339 in an upward direction to cause the door to rotate upward into a closed position.

The end tool 338 may include a camera 336 or some other sensor that can be used to confirm that the par-baked pizza, or other food item, has been deposited into the kitchen appliance compartment 355. The end tool 338 may then move the pizza peel portion of the end tool 338 out of the kitchen appliance compartment 355 and use the finger extension 339 to close the door 354 to the kitchen appliance. The transfer robot 353 can move the end tool 338 to transfer a food item, such as a fully baked pizza, out of the kitchen appliance compartment 355 of the kitchen appliance. To retrieve a pizza from the compartment 355, the transfer robot 353 may open the door 354 of the appropriate kitchen appliance with the finger extension 339 as described above, and then maneuver the pizza peel portion of the end tool 338 into the kitchen appliance compartment 355 underneath the pizza or food item that was being cooked within the kitchen appliance compartment 355. For example, the transfer robot 353 may slide the pizza peel portion of the end tool 338 into the kitchen appliance compartment 355 proximate the bottom surface of the kitchen appliance compartment 355, angled slightly downward toward a back of the kitchen appliance compartment, to cause the pizza to slide onto the pizza peel. The end tool 338 may include a camera 336 or some other sensors that can be used to confirm that the pizza, or other food item, has been onto the pizza peel. The end tool 338 may then move the pizza peel portion of the end tool 338, along with the retrieved pizza or food item, out of the kitchen appliance compartment 355 and use the finger extension 339 to close the door 354 to the kitchen appliance. In some implementations, the pizza peel portion of the transfer robot 353 may include a conveyor that may be used to deposit a food item into and/or retrieve a food item from the interior of the kitchen appliance compartment 355.

The transfer robot 353 may have an end tool 338 that includes a bottom platform and opposable fingers. The bottom platform is disposed at a lower position than the opposable fingers. The bottom platform may hold a box for packing meal kit in place. The bottom platform may also include a bottom surface and two opposing side surfaces. The two side surfaces may move toward or away from each other such that the box for packing meal kit can be hold steady during packing. The opposable fingers may actuate the movement toward each other to grab a food item out from a compartment 355. While holding the food item, the opposable fingers may actuate any three-dimensional movement in relation to the box. With the three-dimensional movement in relation to the box, the opposable fingers may place the food item in a predetermined position within the box. As noted above, a packing or boxing robot may operate independently of or in cooperation with transfer robot 353 to perform or to facilitate some or all of the foregoing functionality.

In some implementations, some kitchen appliances 346, 349 may store thermal packs. Thermal packs may comprise water, gel, ethylene glycol, glycerol, etc. Thermal packs may be packaged with suitable materials for both being frozen (e.g., in a freezer) and heated (e.g., in a microwave or baking oven). The thermal pack is able to passively maintain its temperature within a range (e.g., −10˜0° C., 0˜5° C., 10˜25° C., 60˜85° C.) for a certain period of time, (e.g., half to one hour, one to two hours, etc.) In some implementations, the box for packing meal kit includes a plurality of cells for different food items to be disposed/stored within. In some implementations, the transfer robot 353 may pick appropriate thermal packs with desired temperature and put the thermal packs at the bottom of each cells of the box before disposing any food item.

For example, a meal kit may include a vegetable item that is desired to be refrigerated at 4° C., a meat item that is desired to be frozen at −5° C., and a carbohydrate item is desired to be stored at room temperature. The robot 353 may pick a first thermal pack that is at 0˜5° C. and put it at the bottom of a first cell of a box. The robot 353 may further pick the vegetable item and put it on top of the first thermal pack in the first cell of the box. The robot 353 may pick a second thermal pack that is at −10˜0° C. and put it at the bottom of a second cell of the box. The robot 353 may further grab the meat item and put it on top of the second thermal pack in the second cell of the box. The robot 353 may grab a third thermal pack (or grab nothing at all if the ambient temperature is at the room temperature, i.e., 25° C.) and put it at the bottom of a third cell of the box. The robot 353 may further grab the carbohydrate item and put it on top of the third thermal pack in the third cell of the box.

The transfer robot 353 may be supported by a transfer robot platform 359 that is moveably coupled to and contained in a frame 340. The frame 340 may include at least two vertical posts 350 that extend from the floor 351 to the ceiling 312 of the cargo area and at least two horizontal posts 352 that extend from the rear wall 331 towards the opening for the loading door 318. One vertical post may be located proximate the opening created by the loading door 318, and the other vertical post may be located proximate the rear wall 331. One horizontal post may be located proximate the ceiling 312, and the other horizontal post may be located proximate the floor 351. The two vertical posts 350 and the two horizontal posts 352 may form the exterior of the frame 340.

The frame 340 may include at least two interior vertical posts 350 that couple with and support the transfer robot platform 359. The two interior vertical posts 350 may extend between, and may be movably coupled to, the two horizontal posts 352. For example, in some implementations, one or both of the horizontal posts 352 may include a set of tracks to which the two interior vertical posts 350 couple. One or more motors or other actuators may be used to move the two interior vertical posts 350 along the length of the cargo area. In some implementations, the transfer robot platform 359 may be selectively, movably coupled to the two interior vertical posts 350 using one or more motors or other actuators that enable the transfer robot platform 359 to move up or down relative to the height of the cargo area. The control system 334 may provide commands that control the length-wise movement of the two interior vertical posts 350, as well as provide commands that control the vertical movement of the transfer robot platform 359. Such commands may be used, for example, to position the transfer robot 353 such that the end tool 338 can enter into each of the compartments 355 for each of the kitchen appliances contained with the cargo area.

FIG. 3C includes an isometric view of a portion of a cargo area of a truck that may be used to prepare meal kit during delivery with a left-hand interior side wall cut away and including storage components secured to the side walls, arranged in accordance with at least some embodiments described herein.

Diagram 300C shows a rack 373 arranged against a side wall 343 of the cargo area. The rack 373 may include shelves 372, 374 with varying heights and may be used to store food products such as meal kits. Furthermore, an ingredient/topping container 361 may also be arranged against the side wall 343. The ingredient/topping container 361 may include slots or similar storage units 362 to store various ingredients and/or toppings for the food products to be prepared. Dispensing robots 364, 365 for different dispensing operations and/or ingredients may be arranged along a dispensing system frame 366, which may comprise vertical posts 363, 371 and a cross-bar 370. The dispensing robots 364, 365 may pick and dispense ingredients into individual cells of a meal kit box based on instructions from the controller 334, for example.

FIG. 3D includes an isometric view of a portion of a cargo area of a truck that may be used to prepare meal kit during delivery with a right-hand interior side wall cut away and including packing, preparation, and storage components secured to the side walls and a user with an AR device to control the various components, arranged in accordance with at least some embodiments described herein.

Diagram 300D shows the cargo area of the delivery vehicle with a user 384 (e.g., staff member) wearing an AR device 380. The AR device 380 is wirelessly connected to the on-board control system 334 and/or the off-board control system. The control systems may feed step-by-step visual and audio instructions to the user to pick up the food item according to the order taken for the meal kit. The visual instructions are displayed to the user through the display portion 382 of the AR device 380.

For example, a meal kit may include a vegetable item that is desired to be refrigerated at 4° C., a meat item that is desired to be frozen at −5° C., and a carbohydrate item that is desired to be stored at room temperature. The display portion 382 may feed a visual instruction by highlighting a first kitchen appliance that has a compartment temperature of 0˜5° C. where a first thermal pack is stored. The user 384 may follow the visual instruction and pick a first thermal pack. The display portion may feed a visual instruction by highlighting a first cell of a box for packing the meal kit. The user 384 may follow the visual instruction and put the first thermal pack at the bottom of a first cell of a box. The display portion 382 may feed a visual instruction by highlighting a kitchen appliance wherein the vegetable item is stored. The user 384 may follow the visual instruction to pick up the vegetable item from the kitchen appliance. The display portion 382 may feed a visual instruction by highlighting a second cell of the box for packing meal kit. The user 384 may follow the visual instruction to put the vegetable item on top of the first thermal pack within the first cell of the box. The display portion 382 may feed a visual instruction by highlighting a second kitchen appliance that has a compartment temperature of −10˜0° C. where a second thermal pack is stored. The user 384 may follow the visual instruction to pick up the second thermal pack. The display portion 382 may feed a visual instruction by highlighting a second cell of the box. The user 384 may follow the visual instruction and put the second thermal pack at the bottom of the second cell of the box.

The display portion 382 may feed a visual instruction by highlighting a kitchen appliance where the meat item is stored. The user 384 may follow the visual instruction and pick up the meat item from the temperature controller. The display portion 382 may feed a visual instruction by highlighting the second cell of the box. The user 384 may follow the visual instruction and put the meat item on top of the second temperature pack within the second cell of the box. The display portion 382 may feed a visual instruction by highlighting a third kitchen appliance that has a compartment temperature of 20˜25° C. wherein a third thermal pack is stored. The user 384 may follow the visual instruction to pick up the third thermal pack. The display portion 382 may feed a visual instruction by highlighting a third cell of the box. The user 384 may follow the visual instruction and put the third thermal pack at the bottom of the third cell of the box. The display portion 382 may feed a visual instruction by highlighting a kitchen appliance where the carbohydrate item is stored. The user 384 may follow the visual instruction and pick up the carbohydrate item from the temperature controller. The display portion 382 may feed a visual instruction by highlighting the third cell of the box. The user 384 may follow the visual instruction and put the carbohydrate item on top of the third temperature pack within the third cell of the box.

In one embodiment the monitoring device 332 is a camera that feeds real-time image back to the control system 334. The control system determines, based on the real-time images, whether the instruction was followed. When each visual instruction was displayed through the display portion 382, corresponding audio instructions may also be played through the speaker of the ear piece portion. If the user 384 did not follow the instruction correctly, the visual warning instruction can be displayed through the display portion and/or the audio warning instruction can be display through the speaker.

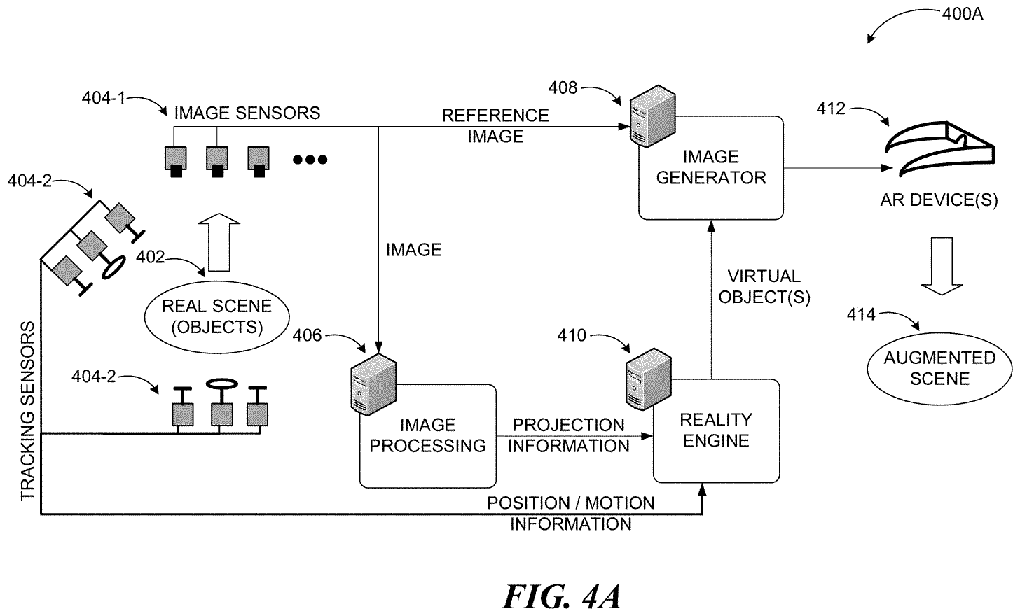

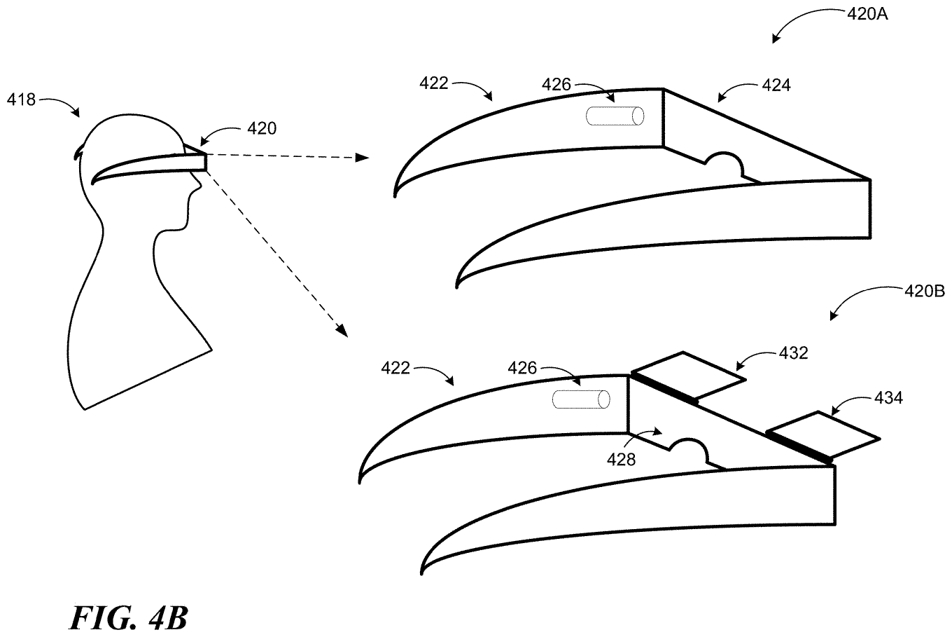

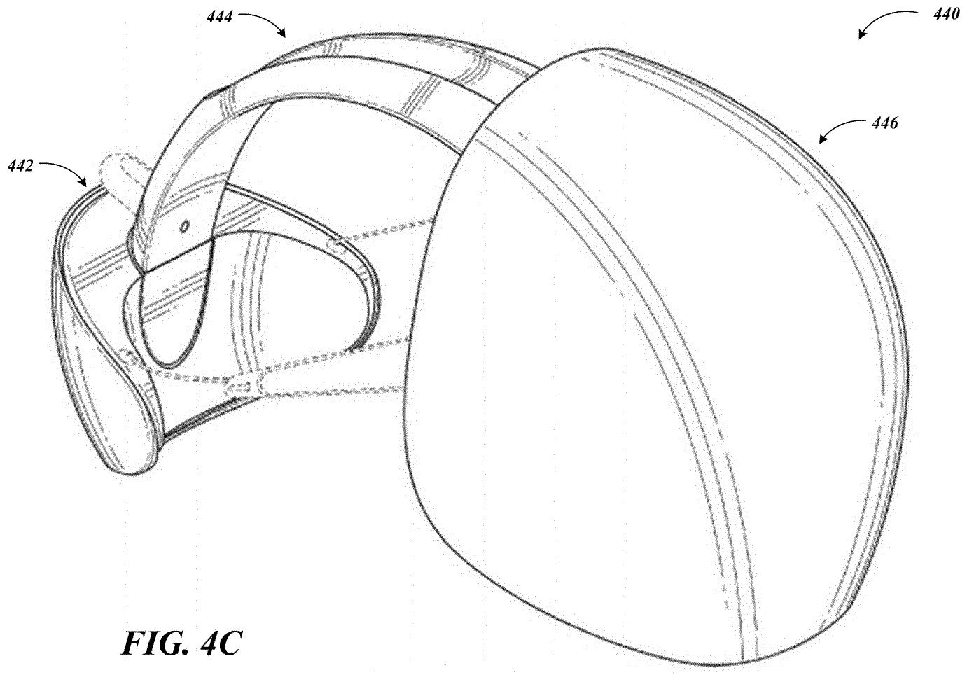

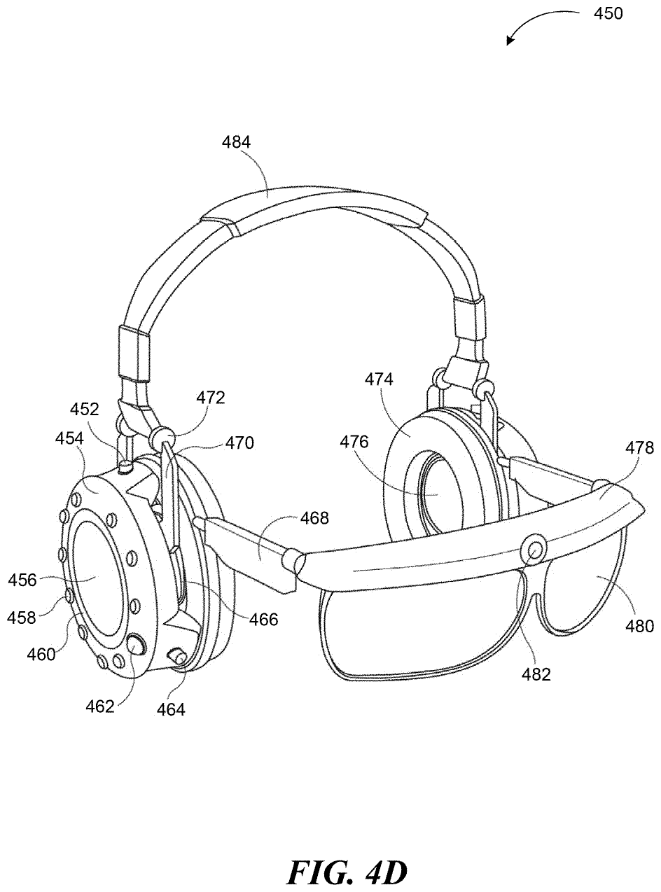

FIG. 4A illustrates an example AR system to display an augmented scene to a user, arranged in accordance with at least some embodiments described herein.

AR explores the application of computer-generated imagery in live video streams to expand the real-world presentation. Example AR systems may be in controlled environments containing a number of sensors and actuators, may include one or more computing device adapted to process real and computer-generated imagery, and may include visualization systems such as head-mounted displays (AR eyeglasses, AR helmets, or AR headsets), virtual retinal displays, monitor or similar regular displays, and comparable devices.

Example AR system 400A includes image sensors 404-1 for capturing live images of real scene (objects) 404 such as food items, equipment, packaging material, as well as tracking sensors 404-2 for tracking a position and/or a motion of the objects (e.g., robotic devices). Image sensors 404-1 may be digital cameras, webcams, or some other image capturing devices. Tracking sensors 404-2 may include a number of receiving devices arranged in a passive sensing network to enhance tracking performance through frequency, bandwidth, and spatial diversity of the network. The receiving devices (e.g., one or more RF receivers) may be adapted to utilize communication signals (e.g., electromagnetic waves such as RF signals) from nearby signal sources such as communication towers (e.g., cellular telephony communication towers) or communication base stations. Tracking sensors 404-2 may be located in different positions and may be communicatively coupled to a centralized or distributed computing system form the collaborative network.

The captured image(s) may be provided to an image processing sub-system 406, which may be adapted to perform one or more of digitization of images into digital images, receipt of digital images, and/or processing digital images. Processing of digital images may include one or more of determining locations of feature points in the images, computation of affine projections, tracking of edges, filtering, and/or similar operations. Image processing sub-system 406 may be configured to provide projection information, such as one or more of the results of the above described operations, to reality engine 410. Tracking sensors 404-2 may be configured to provide position and/or motion information associated with objects of interest in real scene 402 to reality engine 410. Reality engine 410 may be adapted to execute a graphics process to render scenes based on the captured images that incorporates position and/or motion information from tracking sensors 404-2.

Image generator 408 may be adapted to receive reference image(s) from image sensors 404-1 as well as image data associated with virtual object(s) and may be adapted to overlay the captured real scene images with the image data associated with the virtual object(s) to provide an augmented scene 414. AR device(s) 412 are one example visualization mechanism that may be utilized in AR system 400. AR device(s) 412 may be implemented as single (mono) or stereo display.

In an example scenario, the real scene may include the preparation, packaging, and storage compartment of a delivery vehicle. Robotic devices in the compartment may pick, move, and place food items into portions of meal kit boxes autonomously or semi-autonomously. A user with AR device 412 may be displayed the scene along with controls for the robotic devices. The augmentation in the presented view may include highlighting of food items to be picked. Thus, the user may control the robotic devices to pick and place the highlighted food items.

Processing for at least some of the components of AR system 400 such as image processing sub-system 406, reality engine 410, image generator 408, and/or AR device(s) 412 may be performed by separate applications, one or more integrated applications, one or more centralized services, or one or more distributed services on one or more computing devices. Each computing device may be either a general purpose computing device or a special purpose computing device that may be a standalone computer, a networked computer system, a general purpose processing unit (e.g., a micro-processor, a micro-controller, a digital signal processor or DSP, etc.), or a special purpose processing unit. If executed on different computing devices, various components of the AR system 400 may be adapted to communicate over one or more networks.

FIG. 4B illustrates example AR glasses to display an augmented re-configurable environment for meal kit preparation, arranged in accordance with at least some embodiments described herein.

AR eyeglasses function essentially as a portable computer display. They may be see-through or non-see-through (i.e., video cameras providing real world data). AR eyeglasses may also include virtual reality goggles and similar implementations. AR glasses 420 shown in FIG. 4B may be worn by a user 418 to view an augmented scene as discussed above. Various styles of AR glasses may be implemented. For example, AR glasses 424 are an example of plain glass configuration, where the augmented scene may be displayed on LCD or similar glasses, where a controller managing the display may be embedded or attached to the arms 422 of the AR glasses 424 as shown in configuration 420A. Alternatively or additionally, a miniature projector 426 may be attached to the arms 422 and project the augmented scene onto the glasses.

Configuration 420B shows another AR glass variation with a flip-up feature. The flip-up flaps 432, 434 may be used to activate the AR glasses. In one example, the flaps 432 and 434 may include the display while the glasses 428 may be passive glasses. The AR capability may be activated when the flaps 432 and 434 are flipped down. In another example, the glasses 428 may include the AR display, and the AR capability may be turned off when the flaps are flipped down.

In addition to displaying an augmented scene with information for the user, an AR system may also allow the user to control equipment and robotic devices in a preparation, packaging, and storage environment as discussed previously. In the latter examples, some of the controls may be implemented on the AR glasses. For example, proximity sensors on the arms and/or bridge of the AR glasses may be arranged to receive control input form the user and relay to a controller for control of the equipment and robotic devices in the preparation, packaging, and storage environment. The sensors may include capacitive sensors, inductive sensors, magnetic sensors, sonar sensors, optical sensors (photocell or laser), thermal infrared sensors, mechanical switches, and similar ones. The sensors may be configured to receive wearer input, via tapping or touching, regarding equipment control, but also AR operation control such as audio volume control, brightness display of the AR eyeglasses, turning on or off the AR glasses, and so on. The sensors may be located on the inside or outside of the arms of the AR glasses.

FIG. 4C illustrates an example AR helmet to display an augmented re-configurable environment for meal kit preparation, arranged in accordance with at least some embodiments described herein.

AR devices may include any wearable computer display including virtual reality displays and helmet style displays. AR helmet 440 shown in FIG. 4C is another example AR device. The AR helmet 440 includes a head cover 446, a support portion 444, and AR display 442. The AR display 442 may have functionality similar to the AR glasses in FIG. 4B.

An AR device (e.g., the AR helmet 440) may indicate a food preparation and storage equipment for storage or preparation of a food item associated with a received food product order to the user in an AR vision of the re-configurable environment. The AR device may prompt the user to move the food item to another of the one or more food preparation and storage equipment, move the food item into a food delivery packaging, remove the food item from the one of the one or more food preparation and storage equipment, or place a new food item into the one of the one or more food preparation and storage equipment through the AR vision of the re-configurable environment. The AR device may also enable the user to control operation of a robotic arm to move or process a food item associated with a received food product order.

In some examples, the AR device may enable the user to control an operational parameter of a food preparation and storage equipment for storage or preparation of a food item associated with a received food product order. The operational parameter may include one or more of a heating temperature, a cooling temperature, a storage temperature, a food item processing step, a timing for the food item processing step. The food item processing step may include one or more of washing, peeling, seeding, destemming, cutting, dicing, slicing, crushing, pureeing, blending, steaming, cooking, heating, broiling, boiling, simmering, frying, cooling, freezing, pressing, crushing, grinding, pasteurizing, fermenting, sterilizing, or packaging of the food item. The food item processing step may be one or more of an initiation time, a duration, or a termination time for the food item processing step.

The AR device may be communicatively coupled to the on-board controller via wireless or wired communications. In some examples, the on-board controller may receive a food product order and transmit instructions associated with the received food product order to the AR device. The AR device, in turn, may perform one or more actions based on the instructions received from the on-board controller. The actions may include indicating a food preparation and storage equipment for storage or preparation of a food item associated with the received food product order to the user in an AR vision of the re-configurable environment, enabling the user to control operation of a robotic arm to move or process the food item associated with the received food product order, or enabling the user to control an operational parameter of the food preparation and storage equipment for storage or preparation of the food item associated with the received food product order. In other examples, the on-board controller may receive an update to the received food product order and transmit instructions associated with the updated food product order to the AR device. The AR device, based on the instructions received from the on-board controller, may perform one or more modified actions based on the updated food product order. The food product order and the update to the received food product order may be received prior to a departure of the vehicle from a starting point or waypoint. Alternatively, the food product order may be received prior to the departure of the vehicle from the starting point or waypoint and the update to the received food product order may be received while the vehicle is en route. Additionally, the food product order and the update to the received food product order may be received while the vehicle is en route.

FIG. 4D illustrates an example AR headset to display an augmented re-configurable environment for meal kit preparation, arranged in accordance with at least some embodiments described herein.

Diagram 450 depicts a modular headphone assembly-structured AR headset according to some examples. As illustrated in diagram 450, the AR device headset may include a flexible or elastically deformable hemispherical strap-like element 484 designed to be worn atop a user's head. In some embodiments, the strap-like element 484 may comprise multiple, adjustable portions such that a user can expand or contract the element to fit snuggly against the user's head and can be cushioned in various locations along the head-engaging span for comfort. Each end of strap-like element 484 may be connected to an attachment member 470 which, in turn, is connected to an ear piece portion 454. In some embodiments, an air gap is present between a cover piece 454 and ear piece portion 466. In this embodiment, the air gap can provide cooling air flow and heat dissipation from a cover piece 454. In this embodiment, cover piece 454 may include one or more ventilation slots or heat sink fins or structures facing the air gap to allow for passive heat transfer. In some embodiments, strap-like element 484 may be connected to attachment member 470 via rotatable disc 472 which can be spring or tension loaded to allow relative retaining motion for fit and comfort proximate, around, or over the wearer's ear.

In some examples, rotatable disc 472 may enable the inward and outward movement of ear piece portion 466. In some embodiments, arms 468, crossbar 478, and display portion 480 may be removed from the AR headset. Thus, rotatable disc 472 allows for movement of ear piece portion 466 (and cover piece 454) akin to the movement of traditional headphones. In one embodiment, strap-like element 484 may include necessary components to render AR scenes to display portion 480. In some embodiments, strap-like element 484 may include an electrical or optical connector to allow for the connection of additional processing devices. For example, a user may connect a device containing one or more processing elements (e.g., additional AR processing elements described herein) having a connection into a connection port present on the top of strap-like element 484. In other embodiments, cover piece 454 may include an input device 462. The input device may communicate with a control system wirelessly, where images and audio instructions can be communicated.

In some embodiments, input device 462 may comprise a trackball device configured to control interaction with display portion 480. Input device 462 may include haptic rumble, pressure sensitivity, and/or modal click functionalities. Input device 462 may additionally include one or more navigational buttons (e.g., a “forward” or “back” button) to enable a user to navigate through user interfaces displayed on display portion 480. As discussed previously, cover piece 454 may be configured to transmit data to display portion 480 via arm 468 and crossbar 478. In one embodiment, arm 468 may comprise a bus connecting ear piece portion 466 (and thus, cover piece 454) to crossbar 478. In alternative embodiments, arm 468 may additionally be configured with additional processing devices (e.g., devices to support head tracking, position tracking, or light field capture). In some embodiments, a cover piece 454 on the side of strap-like element 484 may be configured to drive a single display. For example, a cover piece 454 on the left side of strap-like element 484 may be configured to drive a display on the left side of display portion 480. Likewise, a cover piece on the right side of strap-like element 484 may drive a display on the right side of display portion 480, or a single device may control both sides.

As illustrated, display portion 480 is connected to ear piece via arm 468. In one embodiment, display portion 480 may be detachable. Crossbar 478 may include one or more processors or other components for controlling the display portion 480. For example, crossbar 478 may include a generic controller, a dedicated microcontroller, cache memory, eye tracking processor, and/or other components. However, crossbar 478 is not required to include processing elements for generating three-dimensional scenes. Instead, three-dimensional scenes may be processed and transmitted to display portion 480 from one or more cover pieces 454 or headband based processors or external sources using scene data collected by components of AR headset.

A remote control system may feed step-by-step visual and audio instructions to the user to pick up a food item according to an order taken for a meal kit. The visual instructions may be displayed to the user through the display portion 480. For example, a meal kit may include a vegetable item that is desired to be refrigerated at 4° C., a meat item that is desired to be frozen at −5° C., and a carbohydrate item that is desired to be stored at room temperature. The display portion may feed a visual instruction by highlighting a first kitchen appliance that has a compartment temperature of 0˜5° C. wherein a first thermal pack is stored. The user may follow the visual instruction and pick a first thermal pack. The display portion 480 may feed a visual instruction by highlighting a first cell of a box for packing the meal kit. The user may follow the visual instruction and put the first thermal pack at the bottom of a first cell of a box. The display portion 480 may feed a visual instruction by highlighting a kitchen appliance wherein the vegetable item is stored. The user may follow the visual instruction to pick up the vegetable item from the kitchen appliance. The display portion 480 may then feed a visual instruction by highlighting a second cell of the box for packing meal kit. The user may follow the visual instruction to put the vegetable item on top of the first thermal pack within the first cell of the box. The display portion 480 may feed a visual instruction by highlighting a second kitchen appliance that has a compartment temperature of −10˜0° C. wherein a second thermal pack is stored. The user may follow the visual instruction to pick up the second thermal pack. The display portion 480 may feed a visual instruction by highlighting a second cell of the box. The user may follow the visual instruction and put the second thermal pack at the bottom of the second cell of the box. The display portion 480 may feed a visual instruction by highlighting a kitchen appliance wherein the meat item is stored. The user may follow the visual instruction and pick up the meat item from the temperature controller. The display portion 480 may feed a visual instruction by highlighting the second cell of the box. The user may follow the visual instruction and put the meat item on top of the second temperature pack within the second cell of the box. The display portion 480 may feed a visual instruction by highlighting a third kitchen appliance that has a compartment temperature of 20˜25° C. wherein a third thermal pack is stored. The user may follow the visual instruction to pick up the third thermal pack. The display portion 480 may feed a visual instruction by highlighting a third cell of the box. The user may follow the visual instruction and put the third thermal pack at the bottom of the third cell of the box. The display portion 480 may feed a visual instruction by highlighting a kitchen appliance wherein the carbohydrate item is stored. The user may follow the visual instruction and pick up the carbohydrate item from the temperature controller. The display portion 480 may feed a visual instruction by highlighting the third cell of the box. The user may follow the visual instruction and put the carbohydrate item on top of the third temperature pack within the third cell of the box.

In one embodiment, a monitoring device 482 may be a camera that feeds real-time image back to the control system. The control system may determine, based on the real-time images, whether the instruction was followed. When each visual instruction was displayed through the display portion 480, corresponding audio instructions may also be played through the speaker 476 of the ear piece portion 474. If the user did not follow the instruction correctly, the visual warning instruction can be displayed through the display portion and/or the audio warning instruction can be display through the speaker 474. The AR device may include the monitoring device 482 (e.g., a camera, RFID reader) that monitors whether the user is following the instructions. Located on the outside of cover piece 454 are multiple openings, apertures or mounting positions referred to herein interchangeably as “dots” 458. In various embodiments, dots 458 may house or retain various components for performing AR-specific operations. For example, dots 458 may house capture devices (e.g., cameras) or tracking devices (e.g., RFID/RFID readers) or combinations thereof. In some embodiments, cover piece 454 may be equipped with only capture devices or with only tracking devices in or at each rivet. In alternative embodiments, cover piece 454 may be configured with both capture devices and tracking devices at or in each of dots 458. The cover piece 454 may include a control element (e.g., a touch sensitive scroll wheel) that may play the step-by-step instructions forward or backward.

In some examples, a capture device may include a camera and/or an LED. The LED may be utilized to illuminate a physical space while the camera records images at one or more angles. In some embodiments, an LED and camera can be combined into a single rivet, while in alternative embodiments (discussed herein) LEDs and cameras may be placed in individual dots at various locations on the puck. In some embodiments, other light sources other than LEDs can be used in place of LEDs. In some embodiments, a light source placed in or at dots 458 may comprise a polarized light source, unpolarized light source, laser diode, infrared (IR) source or combinations thereof. As used herein a light source can be a device that emits electromagnetic or photonic energy in visible or invisible wavelengths. In one embodiment, images captured by capture devices can be used to collect image data that can be used for generating content, including AR content. In some embodiments, the images captured by the multiple capture devices in or at dots 458 may be stored in memory present within the cover piece 454 and used for later display as a three-dimensional scene via crossbar 478 and display portion 480. In some embodiments, the cameras may be fitted with wide angle lenses or fisheye lenses. Thus, in some embodiments, cover piece 454 may be configured as a portable light field or reflectance field capture device and can transmit light field or reflectance field image data to display portion 454 or to other devices on or in communication with the AR headset. In one embodiment, cover piece 454 may allow a user to view a three-dimensional rendering of a space in real-time or near-real time. To enable this operation, cover piece 454 may be configured with one or more processors to process light field or reflectance field images or to send some or all raw light field data to an external device and receive a stream of further processed data representing the AR scene to be rendered.

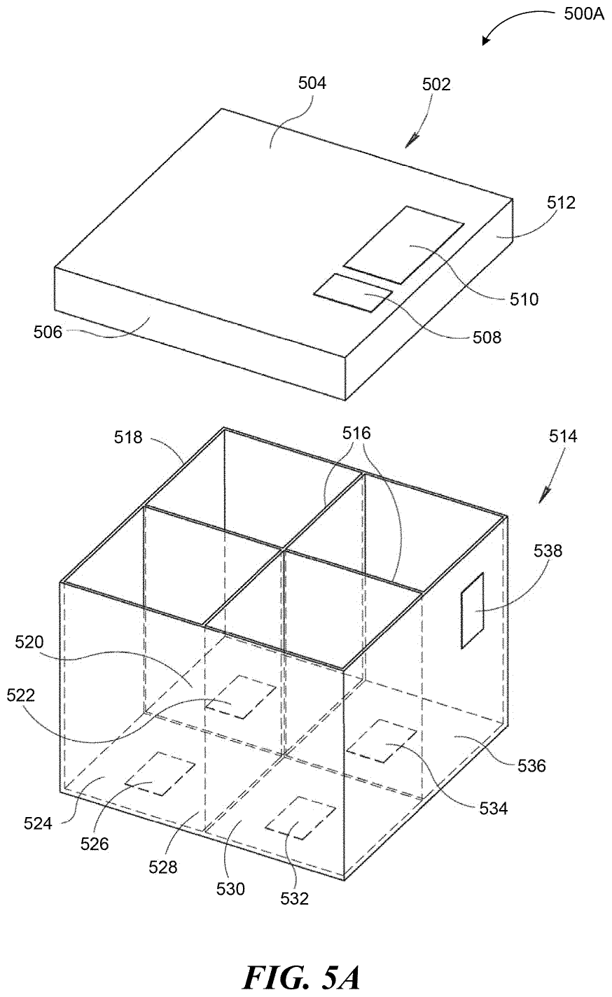

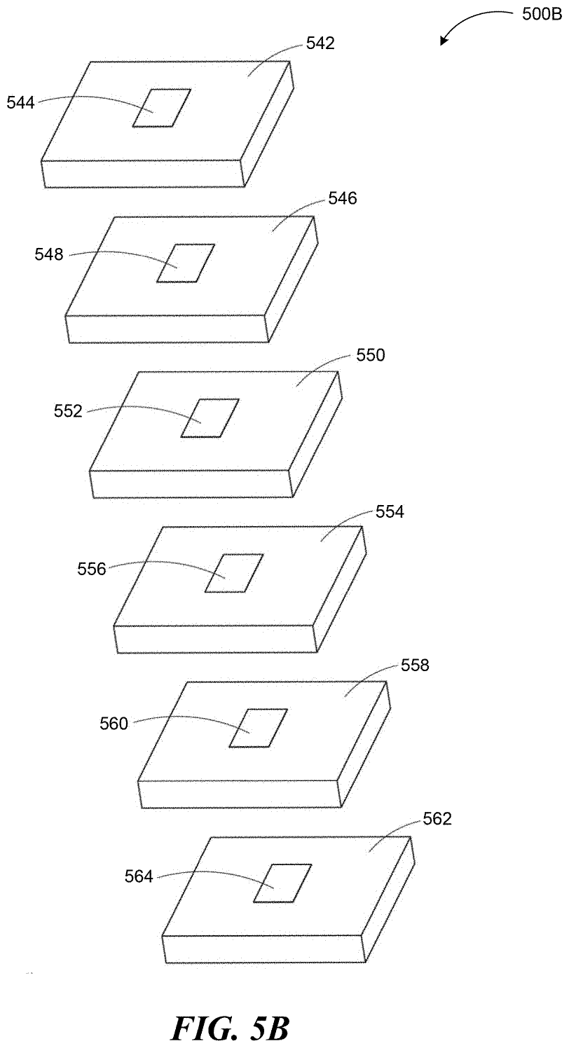

FIG. 5A illustrates a box for packing food items of meal kits, arranged in accordance with at least some embodiments described herein.

FIG. 5A shows a box 500A for packing meal kit according to one implementation of the disclosure. The box 500A includes a lid 502 and a body 514. The lid 502 includes a flat panel 504 and one or more side walls 506, 512 protruding downward from the flat panel 504. The one or more side walls 506, 512 circumscribes the flat panel 504. When the lid 502 properly covers a top surface of the body 514, the interior surfaces of the side walls 506, 512 of the lid 502 are in contact with the exterior surfaces of the side walls 518 of the body 514. The lid 502 may loosely seal a top surface of the body 514 obstructing the free flow of air to maintain one or more temperatures within the box 500A. The lid 502 may further include an identification (ID) tag 508. The ID tag 508 can be any text, graph, code (e.g., QR code), and passive or active electronic device (e.g., RFID tags, transducers, radio emitters, etc.) that uniquely identifies the lid 502. The lid 502 may further include a label 510 attached on top of the exterior surface of the flat panel 504. The label 510 may include text showing the order information, including names of the meal kits, ingredients of the meal kits, ordered time, unit/total price, order confirmation number, advertising/marketing information, etc. The label 510 may also include a QR code that links to an independent database that stores the order information.

The body 514 includes a flat panel 528 and one or more side walls 518 protruding upwards from the flat panel 528. The body 514 may include one or more dividing walls 516. The dividing walls 516 divide the interior space of the body 514 into different cells 520, 524, 530, 536. Each cell may include an identification (ID) tag (522, 526, 532, 534). The body 514 itself may also include an identification (ID) tag 538. The ID tags 522, 526, 532, 534, and 538 can be texts, graphs, codes (e.g., QR codes), passive or active electronic devices (e.g., RFIDs, transducers, radio emitters, etc.) that uniquely identify the cells 520, 524, 530, 536 or the body 514, respectively. The flat panel 528 and/or one or more side walls 516 of the lid 502 can be thermal insulation structure/materials (“insulating wall”). The flat panel 528, side walls 516, and/or the dividing walls 522 can be thermal insulation structure/material (“insulating wall”). Insulating wall can be a multilayered structure. In one implementation, the insulating wall may include at least two layers (e.g., paper, plastic, metal, etc.) with an interior space between the layers. In one example, the insulating wall includes a paper layer disposed externally and an aluminum layer disposed internally with micro-powders filled within. In one example, the insulating wall includes a paper layer disposed externally and a plastic layer disposed internally (or vice versa) with micro-powders filled within.

In another example, the insulating wall includes a plastic layer disposed externally and an aluminum layer disposed internally with micro-powders filled within. The cells 520, 524, 530, 536 are structured to receive thermal packs. Each cell 2310 may receive one or more thermal packs. In one implementation, it may be desired to store different foods that require different storing temperature in different cells. Each cell may receive a different thermal pack with the desired temperature. In one example, it may be desired to store refrigerated food items (e.g., 4° C.) in a first cell 524. A first cell 524 may receive a thermal pack of 4° C. at the bottom. Water, drinks, milk, beans, vegetables, breads, and other similar food items desired to be refrigerated can be placed within the first cell 524. A second cell 530 may receive a thermal pack of −10° C. for maintaining food items intended to be frozen, e.g., meat, ice cream, frozen foods, milk shakes, frozen yogurt, frozen drinks, ice cubes, etc. A third cell 536 may receive a thermal pack of 75° C. for maintaining food items intended to be hot, e.g., pizza, cooked food, soup, coffee, hot drink, etc. A fourth cell 520 may receive no thermal pack, because the food items stored in the fourth cell 520 are intended to be kept at room temperature, e.g., dry food, bread, seasonings, etc.

FIG. 5B illustrates various configurable meal kit packs such as a thermal pack, a vegetable pack, a protein pack, a hot food pack, a carbohydrate pack, and a seasoning pack, arranged in accordance with at least some embodiments described herein.

Diagram 500B shows embodiments of thermal pack 542, vegetable pack 546, protein pack 550, hot food pack 554, carbohydrate pack 558, and seasoning pack 562. Thermal pack 542 is a package with material that has sufficient thermal mass to passively maintain the temperature of an appropriately sized, confined space, e.g., a cell 524. Thermal packs 542 may comprise water, gel, ethylene glycol, glycerol, etc. Thermal packs may be packaged with suitable materials for both being frozen (e.g., in a freezer) and heated (e.g., in a microwave or baking oven). In some implementations, some kitchen appliances may store thermal pack 542. The thermal pack is able to passively maintain its temperature (e.g., −10˜0° C., 0˜5° C., 10˜25° C., 60˜85° C.) for a certain period of time, (e.g., half to one hour, one to two hours, etc.) Each thermal pack 542 may include an ID tag 544 that uniquely identifies the thermal pack 542. The ID tag 544 can be any text, graph, code (e.g., QR code), and passive or active electronic device (e.g., RFID tags, transducers, radio emitters, etc.).

Food pack 546 may be used to store vegetables, e.g., spinach, squashes, butternut squash, zucchini, cucumber, pumpkin, spaghetti squash, tomatoes, tubers, turnips, wasabi, water chestnut, watercress, allspice, basil, bay leafs, capers, cardamom, cilantro, cinnamon, cloves, cumin, curry leaves, coriander, chamomile, dill, fennel, jasmine, lavender, lemongrass, licorice root, mint, wintergreen berries or leaves, spearmint leaves, peppermint leaves, mustard seeds, nutmeg, oregano, paprika, parsley, peppercorns, rosemary, sage, sesame seeds, poppy seeds, sunflower seeds, thyme, vanilla beans, and other similar food items. Each food pack 546 may include an ID tag 548 that uniquely identifies the food pack 546. The ID tag 548 can be any text, graph, code (e.g., QR code), and passive or active electronic device (e.g., RFIDs, transducers, radio emitters, etc).

Food pack 550 may be used to store proteins, e.g., beef, pork, turkey, ham, chicken, duck, bacon, lamb, mutton, veal, mahi-mahi, halibut, catfish, swordfish, salmon, cod, tilapia, anchovies, herrings, tuna, bass, catfish, eel, flounder, grouper, haddock, herring, mackerel, sardines, shark, snapper, sole, sturgeon, trout, caviar, crab, prawns, lobsters, shrimp, mussels, clams, octopus, oysters, scallops, squid, escargot, crawfish, and/or natural sausage casings made from animal intestines. These initial or primary ingredients can include synthetic or cultured meat, poultry, fish and/or other seafood. These initial or primary ingredients can also include dairy products, including milk, cow's milk, goat's milk, eggs, chicken eggs, and/or duck eggs. Each food pack 550 may include an ID tag 552 that uniquely identifies the food pack 550. The ID tag 552 can be any text, graph, code (e.g., QR code), and passive or active electronic device (e.g., RFID tags, transducers, radio emitters, etc.).

Food pack 554 may be used to store hot food, hot soups, and hot drinks. Each food pack 554 may include an ID tag 556 that uniquely identifies the food pack 554. The ID tag 556 can be any text, graph, code (e.g., QR code), and passive or active electronic device (e.g., RFID tags, transducers, radio emitters, etc.).

Food pack 558 may be used to store carbohydrates, e.g., rice, noodle, corn, potato, bread, cake, etc. Each food pack 558 may include an ID tag 560 that uniquely identifies the food pack 558. The ID tag 560 can be any text, graph, code (e.g., QR code), and passive or active electronic device (e.g., RFID tags, transducers, radio emitters, etc.).

Food pack 562 may be used to store seasoning ingredients, e.g., oil, pepper, salt, sugar, salad dressings, ketchup, mustard, etc. Each food pack 562 may include an ID tag 564 that uniquely identifies the food pack 562. The ID tag 564 can be any text, graph, code (e.g., QR code), and passive or active electronic device (e.g., RFID tags, transducers, radio emitters, etc). It is noted that the sizes and shapes of the thermal pack 542 and food packs 546, 550, 554, 558, and 562 are symbolic only. Any shape or size of the packages suitable for the intended purposes are included in this disclosure. In one example, food pack 546 for vegetables may be an open ended plastic or paper bag to accommodate the irregular shape of the vegetable. In another example, food pack 550 for protein can be a sealable bag. In another example, food pack 554 for hot soup can be in cup or bowl shape.

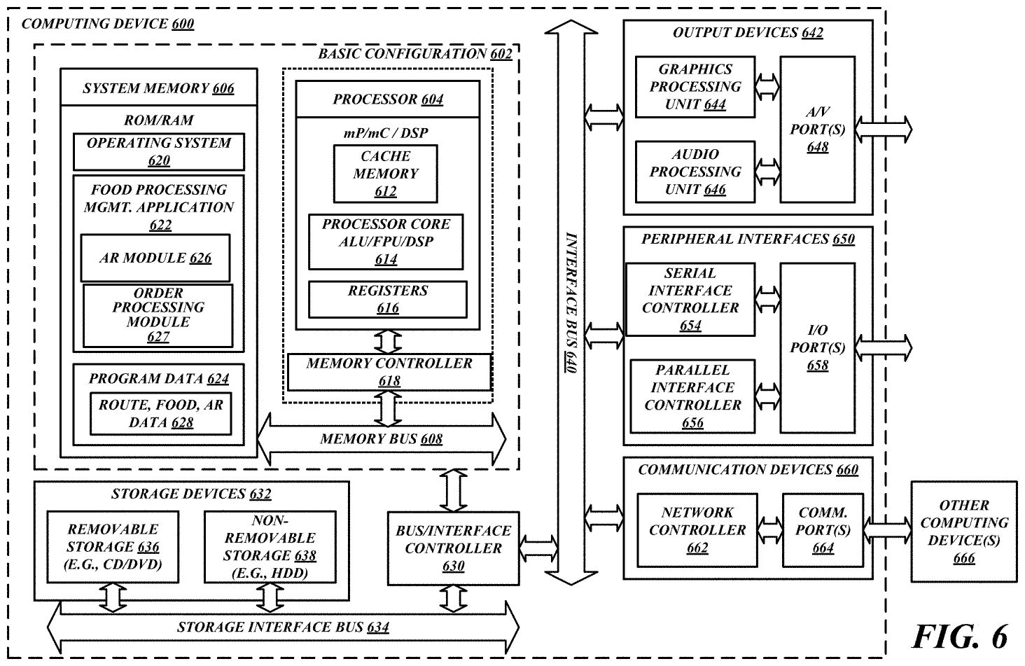

FIG. 6 illustrates a computing device, which may be used to manage an example system for packing, preparation, and storage of configurable meal kits, arranged in accordance with at least some embodiments described herein.

In an example basic configuration 602, the computing device 600 may include one or more processors 604 and a system memory 606. A memory bus 608 may be used to communicate between the processor 604 and the system memory 606. The basic configuration 602 is illustrated in FIG. 6 by those components within the inner dashed line.

Depending on the desired configuration, the processor 604 may be of any type, including but not limited to a microprocessor (μP), a microcontroller (μC), a digital signal processor (DSP), or any combination thereof. The processor 604 may include one or more levels of caching, such as a cache memory 612, a processor core 614, and registers 616. The example processor core 614 may include an arithmetic logic unit (ALU), a floating point unit (FPU), a digital signal processing core (DSP core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.) or any combination thereof. The system memory 606 may include an operating system 620, a food processing management application 622, an AR module 626, and an order processing module 627. The food processing management application 622, in conjunction with the order processing module 627 may receive orders and coordinate preparation, packaging, and storage of food product orders such as meal kits while a delivery vehicle is en route. The AR module 626 may present an augmented scene of the preparation, packaging, and storage environment along with instructions for performing some or all of the preparation, packaging, and storage operations or controlling robotic devices in the environment. The program data 624 may include route, food, and AR data 628, among other data, as described herein. Route data may include destination, available or recommended routes, traffic information, travel time information, etc. Food data may include information associated with food items (e.g., raw materials), desired food products, preparation steps, timings, etc. AR data may include data associated with captured and/or augmented scenes.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices include magnetic disk devices such as flexible disk drives and hard-disk drives (HDDs), optical disk drives such as compact disc (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives (SSDs), or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (e.g., one or more output devices 642, one or more peripheral interfaces 650, and one or more communication devices 660) to the basic configuration 602 via the bus/interface controller 630. Some of the example output devices 642 include a graphics processing unit 644 and an audio processing unit 646, which may be configured to communicate to various external devices such as a display or speakers via one or more A/V ports 648. One or more example peripheral interfaces 650 may include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 660 includes a network controller 662, which may be arranged to facilitate communications with one or more other computing devices 666 over a network communication link via one or more communication ports 664. The one or more other computing devices 666 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include non-transitory storage media.

The computing device 600 may be implemented as a part of a specialized server, mainframe, or similar computer that includes any of the above functions. The computing device 600 may also be implemented as a personal computer including both laptop computer and non-laptop computer configurations.

While delivery trucks, containers, and modular systems are discussed herein as illustrative examples, some embodiments may be directed to methods such as manufacturing or using discussed vehicles and systems for preparation and delivery of configurable meal kits with the assistance of an AR system through the discussed vehicles and systems. Example methods may include one or more operations, functions, or actions some of which may be performed by a computing device such as the computing device 600 in FIG. 6 and/or other general purpose and specialized devices communicatively coupled to the computing device 600. Such operations, functions, or actions may be combined, eliminated, modified, and/or supplemented with other operations, functions or actions, and need not necessarily be performed in a specific sequence.

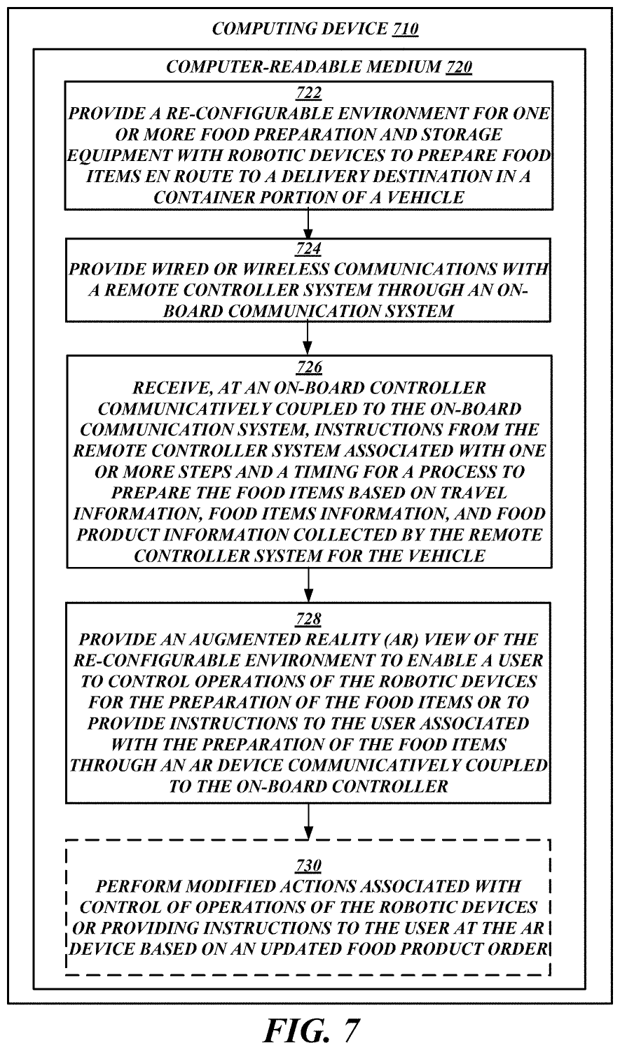

FIG. 7 includes a flow diagram for a process to prepare and deliver configurable meal kits with the assistance of an AR system, arranged in accordance with at least some embodiments described herein.

Example embodiments may also include methods. These methods can be implemented in any number of ways, including the structures described herein. One such way is by machine operations, of devices of the type described in the present disclosure. Another optional way is for one or more of the individual operations of the methods to be performed in conjunction with one or more human operators performing some of the operations while other operations are performed by machines. These human operators need not be collocated with each other, but each can be only with a machine that performs a portion of the program. In other examples, the human interaction can be automated such as by pre-selected criteria that are machine automated. The operations described in blocks 722 through 730 may be stored as computer-executable instructions in a computer-readable medium such as computer-readable medium 720 of computing device 710.

A process of preparing and delivering configurable meal kits with the assistance of an AR system may begin with operation 722, “PROVIDE A RE-CONFIGURABLE ENVIRONMENT FOR ONE OR MORE FOOD PREPARATION AND STORAGE EQUIPMENT WITH ROBOTIC DEVICES TO PREPARE FOOD ITEMS EN ROUTE TO A DELIVERY DESTINATION IN A CONTAINER PORTION OF A VEHICLE,” where a vehicle such as a truck, a railcar, or a watercraft, or a container to be fitted into any one of those vehicles may be equipped with appliances and other equipment to prepare, package, and store food products such as configurable meal kits from ingredients (food items). The preparation, packaging, and storage may be based on orders received prior to departure from a starting point or a waypoint, or updates to orders received while the vehicle is en route.

Operation 722 may be followed by operation 724, “PROVIDE WIRED OR WIRELESS COMMUNICATIONS WITH A REMOTE CONTROLLER SYSTEM THROUGH AN ON-BOARD COMMUNICATION SYSTEM,” where a remote control system may communicate with an on-board controller of the vehicle to provide routing, traffic, road conditions, order, food product processing, and similar information.

Operation 724 may be followed by operation 726, “RECEIVE, AT AN ON-BOARD CONTROLLER COMMUNICATIVELY COUPLED TO THE ON-BOARD COMMUNICATION SYSTEM, INSTRUCTIONS FROM THE REMOTE CONTROLLER SYSTEM ASSOCIATED WITH ONE OR MORE STEPS AND A TIMING FOR A PROCESS TO PREPARE THE FOOD ITEMS BASED ON TRAVEL INFORMATION, FOOD ITEMS INFORMATION, AND FOOD PRODUCT INFORMATION COLLECTED BY THE REMOTE CONTROLLER SYSTEM FOR THE VEHICLE,” where the on-board controller of the vehicle may receive instructions associated with one or more steps and a timing for a process to prepare the food items based on travel information, food items information, and food product information collected by the remote controller system.

Operation 726 may be followed by operation 728, “PROVIDE AN AUGMENTED REALITY (AR) VIEW OF THE RE-CONFIGURABLE ENVIRONMENT TO ENABLE A USER TO CONTROL OPERATIONS OF THE ROBOTIC DEVICES FOR THE PREPARATION OF THE FOOD ITEMS OR TO PROVIDE INSTRUCTIONS TO THE USER ASSOCIATED WITH THE PREPARATION OF THE FOOD ITEMS THROUGH AN AR DEVICE COMMUNICATIVELY COUPLED TO THE ON-BOARD CONTROLLER,” where an AR system on the vehicle, in coordination with the on-board controller of the vehicle, may present an augmented scene of the environment in the vehicle to a user in order to enable the user to participate in the preparation, packaging, and storage of the food products and/or to control robotic devices and appliances in the vehicle.

Operation 728 may be followed by optional operation 730, “PERFORM MODIFIED ACTIONS ASSOCIATED WITH CONTROL OF OPERATIONS OF THE ROBOTIC DEVICES OR PROVIDING INSTRUCTIONS TO THE USER AT THE AR DEVICE BASED ON AN UPDATED FOOD PRODUCT ORDER,” where the AR system and the on-board controller of the vehicle may determine modifications for operations for the preparation, packaging, and storage of the food products based on an updated order and perform those modified operations.

The operations included in the above described process are for illustration purposes. Preparation and delivery of configurable meal kits with the assistance of an AR system may be implemented by similar processes with fewer or additional blocks. In some examples, the blocks may be performed in a different order. In some other examples, various blocks may be eliminated. In still other examples, various blocks may be divided into additional blocks, or combined together into fewer blocks.

According to some examples, a vehicle to prepare food items en route is described. The vehicle may include a container portion configured to provide a re-configurable environment for one or more food preparation and storage equipment with robotic devices to prepare food items en route to a delivery destination; a communication system configured to enable wired or wireless communications with a remote controller system; and an on-board controller communicatively coupled to the communication system and the robotic devices, the on-board controller configured to receive instructions from the remote controller system associated with one or more steps and a timing for a process to prepare the food items based on travel information, food items information, and food product information collected by the remote controller system for the vehicle. The vehicle may also include an augmented reality (AR) device communicatively coupled to the on-board controller. The AR device may be configured to provide an AR view of the re-configurable environment to enable a user to control operations of the robotic devices for the preparation of the food items or to provide instructions to the user associated with the preparation of the food items.

According to other examples, the AR device may be configured to indicate one of the one or more food preparation and storage equipment for storage or preparation of a food item associated with a received food product order to the user in an AR vision of the re-configurable environment. The AR device may be further configured to prompt the user to one of: move the food item to another of the one or more food preparation and storage equipment, move the food item into a food delivery packaging, remove the food item from the one of the one or more food preparation and storage equipment, or place a new food item into the one of the one or more food preparation and storage equipment through the AR vision of the re-configurable environment. The AR device may be further configured to enable the user to control operation of a robotic arm to move or process a food item associated with a received food product order.

According to further examples, the AR device may be further configured to enable the user to control an operational parameter of one of the one or more food preparation and storage equipment for storage or preparation of a food item associated with a received food product order. The operational parameter may be one or more of a heating temperature, a cooling temperature, a storage temperature, a food item processing step, a timing for the food item processing step. The food item processing step may include one or more of washing, peeling, seeding, destemming, cutting, dicing, slicing, crushing, pureeing, blending, steaming, cooking, heating, broiling, boiling, simmering, frying, cooling, freezing, pressing, crushing, grinding, pasteurizing, fermenting, sterilizing, or packaging of the food item. The timing for the food item processing step may include one or more of an initiation time, a duration, or a termination time for the food item processing step. The AR device may include AR glasses, an AR headset, an AR helmet, an AR projection system, or a handheld AR device. The AR device may be communicatively coupled to the on-board controller via wireless or wired communications.

According to yet other examples, the on-board controller may be configured to receive a food product order and transmit instructions associated with the received food product order to the AR device. The AR device, based on the instructions received from the on-board controller, may be configured to perform one or more actions including indicate one of the one or more food preparation and storage equipment for storage or preparation of a food item associated with the received food product order to the user in an AR vision of the re-configurable environment; enable the user to control operation of a robotic arm to move or process the food item associated with the received food product order; or enable the user to control an operational parameter of the one of the one or more food preparation and storage equipment for storage or preparation of the food item associated with the received food product order. The on-board controller may be configured to receive an update to the received food product order and transmit instructions associated with the updated food product order to the AR device; and the AR device, based on the instructions received from the on-board controller, may be configured to perform one or more modified actions based on the updated food product order.

According to some examples, the food product order and the update to the received food product order may be received prior to a departure of the vehicle from a starting point or waypoint, the food product order may be received prior to the departure of the vehicle from the starting point or waypoint and the update to the received food product order may be received while the vehicle may be en route, or the food product order and the update to the received food product order may be received while the vehicle may be en route. The container portion may be compartmentalized to enable distinct environmental conditions for the one or more food preparation and storage equipment and compartments of the container portion are configured to feed each other with outputs of the one or more food preparation and storage equipment in each compartment. The travel information may include one or more delivery destination locations, one or more potential routes between the delivery destinations, road condition information for the potential routes, traffic condition information for the potential routes, or weather condition information for the potential routes; the food items information may include one or more of quantity information, quality information, or type information associated with ingredients for a food product to be prepared; and the food product information may include one or more of quantity information, quality information, type information, or packaging information associated with the food product to be prepared. The vehicle may be a truck, a railway car, an airplane, or a watercraft.

According to other examples, a modular container system for en route food product preparation may be described. The container system may include a container suitable to be fitted onto a truck, a railway car, an airplane, or a watercraft, the container configured to provide a re-configurable environment for one or more food preparation and storage equipment with robotic devices to prepare food items en route to a delivery destination; a communication system configured to enable wired or wireless communications with a remote controller system; and an on-board controller communicatively coupled to the communication system and the robotic devices, the on-board controller configured to receive instructions from the remote controller system associated with one or more steps and a timing for a process to prepare the food items based on travel information, food items information, and food product information collected by the remote controller system for the container. The container system may also include an augmented reality (AR) device communicatively coupled to the on-board controller. The AR device may be configured to provide an AR view of the re-configurable environment to enable a user to control operations of the robotic devices for the preparation of the food items or to provide instructions to the user associated with the preparation of the food items.

According to further examples, the AR device may be configured to indicate one of the one or more food preparation and storage equipment for storage or preparation of a food item associated with a received food product order to the user in an AR vision of the re-configurable environment. The AR device may be further configured to prompt the user to one of: move the food item to another of the one or more food preparation and storage equipment, move the food item into a food delivery packaging, remove the food item from the one of the one or more food preparation and storage equipment, or place a new food item into the one of the one or more food preparation and storage equipment through the AR vision of the re-configurable environment. The AR device may be further configured to enable the user to control operation of a robotic arm to move or process a food item associated with a received food product order.

According to yet other examples, the AR device may be further configured to enable the user to control an operational parameter of one of the one or more food preparation and storage equipment for storage or preparation of a food item associated with a received food product order. The operational parameter may be one or more of a heating temperature, a cooling temperature, a storage temperature, a food item processing step, a timing for the food item processing step. The food item processing step may include one or more of washing, peeling, seeding, destemming, cutting, dicing, slicing, crushing, pureeing, blending, steaming, cooking, heating, broiling, boiling, simmering, frying, cooling, freezing, pressing, crushing, grinding, pasteurizing, fermenting, sterilizing, or packaging of the food item. The timing for the food item processing step may include one or more of an initiation time, a duration, or a termination time for the food item processing step. The AR device may include AR glasses, an AR headset, an AR helmet, an AR projection system, or a handheld AR device. The AR device may be communicatively coupled to the on-board controller via wireless or wired communications.

According to some examples, the on-board controller may be configured to receive a food product order and transmit instructions associated with the received food product order to the AR device. The AR device, based on the instructions received from the on-board controller, may be configured to perform one or more actions including indicate one of the one or more food preparation and storage equipment for storage or preparation of a food item associated with the received food product order to the user in an AR vision of the re-configurable environment; enable the user to control operation of a robotic arm to move or process the food item associated with the received food product order; or enable the user to control an operational parameter of the one of the one or more food preparation and storage equipment for storage or preparation of the food item associated with the received food product order. The on-board controller may be configured to receive an update to the received food product order and transmit instructions associated with the updated food product order to the AR device; and the AR device, based on the instructions received from the on-board controller, may be configured to perform one or more modified actions based on the updated food product order.

According to other examples, the food product order and the update to the received food product order may be received prior to a departure of the vehicle from a starting point or waypoint, the food product order may be received prior to the departure of the vehicle from the starting point or waypoint and the update to the received food product order may be received while the vehicle may be en route, or the food product order and the update to the received food product order may be received while the vehicle may be en route. The container portion may be compartmentalized to enable distinct environmental conditions for the one or more food preparation and storage equipment and compartments of the container portion are configured to feed each other with outputs of the one or more food preparation and storage equipment in each compartment. The travel information may include one or more delivery destination locations, one or more potential routes between the delivery destinations, road condition information for the potential routes, traffic condition information for the potential routes, or weather condition information for the potential routes; the food items information may include one or more of quantity information, quality information, or type information associated with ingredients for a food product to be prepared; and the food product information may include one or more of quantity information, quality information, type information, or packaging information associated with the food product to be prepared.

According to further examples, a method for preparation of food items en route may be described. The method may include providing a re-configurable environment for one or more food preparation and storage equipment with robotic devices to prepare food items en route to a delivery destination in a container portion of a vehicle; providing wired or wireless communications with a remote controller system through an on-board communication system; receiving, at an on-board controller communicatively coupled to the on-board communication system, instructions from the remote controller system associated with one or more steps and a timing for a process to prepare the food items based on travel information, food items information, and food product information collected by the remote controller system for the vehicle; and providing an augmented reality (AR) view of the re-configurable environment to enable a user to control operations of the robotic devices for the preparation of the food items or to provide instructions to the user associated with the preparation of the food items through an AR device communicatively coupled to the on-board controller.

According to some examples, the method may also include indicating through the AR device one of the one or more food preparation and storage equipment for storage or preparation of a food item associated with a received food product order to the user in an AR vision of the re-configurable environment. The method may further include prompting the user through the AR device to one of: move the food item to another of the one or more food preparation and storage equipment, move the food item into a food delivery packaging, remove the food item from the one of the one or more food preparation and storage equipment, or place a new food item into the one of the one or more food preparation and storage equipment through the AR vision of the re-configurable environment. The method may further include providing the user with control of an operation of a robotic arm to move or process a food item associated with a received food product order through the AR device.

According to other examples, the method may further include providing the user with control of an operational parameter of one of the one or more food preparation and storage equipment for storage or preparation of a food item associated with a received food product order through the AR device. The operational parameter may be one or more of a heating temperature, a cooling temperature, a storage temperature, a food item processing step, a timing for the food item processing step. The food item processing step may include one or more of washing, peeling, seeding, destemming, cutting, dicing, slicing, crushing, pureeing, blending, steaming, cooking, heating, broiling, boiling, simmering, frying, cooling, freezing, pressing, crushing, grinding, pasteurizing, fermenting, sterilizing, or packaging of the food item. The timing for the food item processing step may include one or more of an initiation time, a duration, or a termination time for the food item processing step.

According to further examples, the method may further include receiving a food product order at the on-board controller and transmitting instructions associated with the received food product order from the on-board controller to the AR device; and in response to the instructions received from the on-board controller, performing one or more actions at the AR device including: indicating one of the one or more food preparation and storage equipment for storage or preparation of a food item associated with the received food product order to the user in an AR vision of the re-configurable environment; providing the user with control of an operation of a robotic arm to move or process the food item associated with the received food product order; or providing the user with control of an operational parameter of the one of the one or more food preparation and storage equipment for storage or preparation of the food item associated with the received food product order. The method may further include receiving an update to the received food product order at the on-board controller and transmitting instructions associated with the updated food product order from the on-board controller to the AR device; and in response to the instructions received from the on-board controller, performing one or more modified actions at the AR device based on the updated food product order. The method may further include receiving the food product order and the update to the received food product order prior to a departure of the vehicle from a starting point or waypoint, receiving the food product order prior to the departure of the vehicle from the starting point or waypoint and receiving the update to the received food product order while the vehicle may be en route, or receiving the food product order and the update to the received food product order while the vehicle is en route.

According to yet other examples, the travel information may include one or more delivery destination locations, one or more potential routes between the delivery destinations, road condition information for the potential routes, traffic condition information for the potential routes, or weather condition information for the potential routes; the food items information may include one or more of quantity information, quality information, or type information associated with ingredients for a food product to be prepared; and the food product information may include one or more of quantity information, quality information, type information, or packaging information associated with the food product to be prepared.

Certain specific details are set forth herein in order to provide a thorough understanding of various disclosed embodiments. However, one skilled in the relevant art will recognize that embodiments may be practiced without one or more of these specific details, or with other methods, components, materials, etc. In other instances, certain structures associated with food preparation devices such as ovens, skillets, and other similar devices, closed-loop controllers used to control cooking conditions, food preparation techniques, wired and wireless communications protocols, wired and wireless transceivers, radios, communications ports, geolocation, and optimized route mapping algorithms have not been shown or described in detail to avoid unnecessarily obscuring descriptions of the embodiments. In other instances, certain structures associated with conveyors, robots, and/or vehicles have not been shown or described in detail to avoid unnecessarily obscuring descriptions of the embodiments.

As used herein the term “travel information” refers to delivery destination locations, one or more potential routes between the delivery destinations, road condition information (road curvatures, road tilt, expected vehicle tilt, construction, road roughness, etc.) for the potential routes, traffic condition information for the potential routes, weather condition information (temperature, humidity, altitude, winds, wave size, etc.) for the potential routes, licensing information, and any other conditions that may affect travel of the vehicle equipped to prepare food items en route.

As used herein the terms “food item” and “food product” refer to any item or product intended for human consumption. A “food product” is generally understood to be made by preparing “food items”, that is, ingredients, raw or cooked materials, etc., and may also include interim ingredients (e.g., prepared ingredients that may be used to prepare a final food product, e.g., pizza sauce). Although illustrated and described in some embodiments herein in the context of pizza to provide a readily comprehensible and easily understood description of one illustrative embodiment, one of ordinary skill in the culinary arts and food preparation will readily appreciate the broad applicability of the systems, methods, and apparatuses described herein across any number of prepared food items or products, including cooked and uncooked food items or products, and ingredients or components of food items and products. The term “meal kit” refers to a set of foods and ingredients for making a meal for human consumption. The foods and ingredients of the meal kit may be raw, partially cooked, and/or fully cooked.

As used herein the terms “robot” or “robotic” refer to any device, system, or combination of systems and devices that includes at least one appendage, typically with an end of arm tool or end effector, where the at least one appendage is selectively moveable to perform work or an operation useful in the preparation a food item or packaging of a food item or food product. The robot may be autonomously controlled, for instance based at least in part on information from one or more sensors (e.g., optical sensors used with machine-vision algorithms, position encoders, temperature sensors, moisture or humidity sensors). Alternatively, one or more robots can be remotely controlled by a human operator. Alternatively, one or more robots can be partially remotely controlled by a human operator and partially autonomously controlled.

As used herein, the term “food preparation equipment” refers to any equipment or appliance used prepare “food items” including “cooking”, but not limited to. For example, “food preparation equipment” may be used to slice, dice, blend, wash, or otherwise process the “food items”. For example, food preparation equipment refers to any device, system, or combination of systems and devices useful in the preparation of a food product. While such preparation may include ingredient distribution devices, choppers, peeler, cooking units for the heating of food products during preparation, rolling units, mixers, blenders, etc. and such preparation may also include the partial or complete cooling of one or more food products. Further, the food preparation equipment may be able to control more than temperature. For example, some food preparation equipment may control pressure or humidity. Further, some food preparation equipment may control airflow therein, thus able to operate in a convective mode if desired, for instance to decrease preparation time.

As used herein, food preparation refers to any preparation or process of food items to prepare a food product from that food item and may include any one or more of washing, destemming, peeling, mixing, chopping, blending, grinding, cooking, cooling, and packaging, and the time, temperature speed or any other control or environmental factor of that processing step.

As used herein the term “thermal pack” refers to a package of thermal transfer medium that can transfer heat to or absorb heat to maintain a desired temperature within a packing box of a meal kit. Thermal transfer medium of a thermal pack can be passive but could be active. Passive thermal transfer medium may include water, gel, ethylene glycol, glycerol, or the like. Active thermal transfer medium may include one or more materials that produce heat or cold via a chemical reaction, e.g., iron powder, sodium acetate, or the like.

As used herein the term “insulated” or “thermally insulated” means a space, e.g., a box, a cell of a box, etc., is surrounded by materials that form barriers for the heat exchanging between the space and the environment outside of the space. The materials used for insulating a space in the embodiments disclosed herein have a thermal conductivity less than 1 Watt per meter-Kelvin (W/mk), such material include Polyethylene Terephthalate (PET) fiber/powder, Polypropylene (PP) fiber/power, still air, vacuumed space, etc. The materials used for insulating the space may keep the space under a predetermined temperature, e.g., 4° C., for at least a period of time, e.g., 30 minutes. The term “not insulated” or “not thermally insulated” means a space is not surrounded by materials that have an thermal conductivity less than 1 Watt per meter-Kelvin (W/mk). As used herein the term “vehicle” refers to any car, truck, van, train, watercraft, or other vehicle useful in preparing a food item during a delivery process.

There are various vehicles by which processes and/or systems and/or other technologies described herein may be affected (e.g., hardware, software, and/or firmware), and the preferred vehicle will vary with the context in which the processes and/or systems and/or other technologies are deployed. For example, if an implementer determines that speed and accuracy are paramount, the implementer may opt for mainly hardware and/or firmware vehicle; if flexibility is paramount, the implementer may opt for mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, may be equivalently implemented in integrated circuits, as one or more computer programs executing on one or more computers (e.g., as one or more programs executing on one or more computer systems), as one or more programs executing on one or more processors (e.g., as one or more programs executing on one or more microprocessors), as firmware, or as virtually any combination thereof, and that designing the circuitry and/or writing the code for the software and/or firmware are possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive (HDD), a compact disc (CD), a digital versatile disk (DVD), a digital tape, a computer memory, a solid state drive (SSD), etc.; and a transmission type medium such as a digital and/or an analog communication medium (e.g., a fiber optic cable, a waveguide, a wired communication link, a wireless communication link, etc.).

It is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. A data processing system may include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors.

A processing system may be implemented utilizing any suitable commercially available components, such as those found in data computing/communication and/or network computing/communication systems. The herein described subject matter sometimes illustrates different components contained within, or connected with, different other components. Such depicted architectures are merely exemplary, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A vehicle to prepare food items en route, the vehicle comprising:
a container portion configured to provide a re-configurable environment for one or more food preparation and storage equipment with robotic devices to prepare food items en route to a delivery destination;
a communication system configured to enable wired or wireless communications with a remote controller system;
an on-board controller communicatively coupled to the communication system and the robotic devices, the on-board controller configured to receive instructions from the remote controller system associated with one or more steps and a timing for a process to prepare the food items based on travel information, food items information, and food product information collected by the remote controller system for the vehicle; and
an augmented reality (AR) device communicatively coupled to the on-board controller, the AR device configured to:
provide an AR view of the re-configurable environment to enable a user to control operations of the robotic devices for the preparation of the food items or to provide instructions to the user associated with the preparation of the food items.

2. The vehicle of claim 1, wherein the AR device is configured to indicate one of the one or more food preparation and storage equipment for storage or preparation of a food item associated with a received food product order to the user in an AR vision of the re-configurable environment.

3. The vehicle of claim 2, wherein the AR device is further configured to prompt the user to one of: move the food item to another of the one or more food preparation and storage equipment, move the food item into a food delivery packaging, remove the food item from the one of the one or more food preparation and storage equipment, or place a new food item into the one of the one or more food preparation and storage equipment through the AR vision of the re-configurable environment.

4. The vehicle of claim 1, wherein the AR device is further configured to enable the user to control one or more of
an operation of a robotic arm to move or process a food item associated with a received food product order; or
an operational parameter of one of the one or more food preparation and storage equipment for storage or preparation of a food item associated with a received food product order, wherein the operational parameter is one or more of a heating temperature, a cooling temperature, a storage temperature, a food item processing step, a timing for the food item processing step.

5. (canceled)

6. (canceled)

7. (canceled)

8. The vehicle of claim 4, wherein the timing for the food item processing step includes one or more of an initiation time, a duration, or a termination time for the food item processing step.

9. The vehicle of claim 1, wherein the AR device includes AR glasses, an AR headset, an AR helmet, an AR projection system, or a handheld AR device.

10. (canceled)

11. The vehicle of claim 1, wherein
the on-board controller is configured to receive a food product order and transmit instructions associated with the received food product order to the AR device; and
the AR device, based on the instructions received from the on-board controller, is configured to perform one or more actions including:
indicate one of the one or more food preparation and storage equipment for storage or preparation of a food item associated with the received food product order to the user in an AR vision of the re-configurable environment;
enable the user to control operation of a robotic arm to move or process the food item associated with the received food product order; or
enable the user to control an operational parameter of the one of the one or more food preparation and storage equipment for storage or preparation of the food item associated with the received food product order.

12. The vehicle of claim 11, wherein
the on-board controller is configured to receive an update to the received food product order and transmit instructions associated with the updated food product order to the AR device; and
the AR device, based on the instructions received from the on-board controller, is configured to perform one or more modified actions based on the updated food product order.

13. The vehicle of claim 12, wherein
the food product order and the update to the received food product order are received prior to a departure of the vehicle from a starting point or waypoint,
the food product order is received prior to the departure of the vehicle from the starting point or waypoint and the update to the received food product order is received while the vehicle is en route, or
the food product order and the update to the received food product order are received while the vehicle is en route.

14. (canceled)

15. (canceled)

16. (canceled)

17. A modular container system for en route food product preparation, the container system comprising:
a container suitable to be fitted onto a truck, a railway car, an airplane, or a watercraft, the container configured to provide a re-configurable environment for one or more food preparation and storage equipment with robotic devices to prepare food items en route to a delivery destination;
a communication system configured to enable wired or wireless communications with a remote controller system;
an on-board controller communicatively coupled to the communication system and the robotic devices, the on-board controller configured to receive instructions from the remote controller system associated with one or more steps and a timing for a process to prepare the food items based on travel information, food items information, and food product information collected by the remote controller system for the container; and
an augmented reality (AR) device communicatively coupled to the on-board controller, the AR device configured to:
provide an AR view of the re-configurable environment to enable a user to control operations of the robotic devices for the preparation of the food items or to provide instructions to the user associated with the preparation of the food items.

18. The container system of claim 17, wherein the AR device is configured to one or more of:
indicate one of the one or more food preparation and storage equipment for storage or preparation of a food item associated with a received food product order to the user in an AR vision of the re-configurable environment;
prompt the user to one of: move the food item to another of the one or more food preparation and storage equipment, move the food item into a food delivery packaging, remove the food item from the one of the one or more food preparation and storage equipment, or place a new food item into the one of the one or more food preparation and storage equipment through the AR vision of the re-configurable environment;
enable the user to control operation of a robotic arm to move or process a food item associated with a received food product order; or
enable the user to control an operational parameter of one of the one or more food preparation and storage equipment for storage or preparation of a food item associated with a received food product order.

19. (canceled)

20. (canceled)

21. (canceled)

22. (canceled)

23. (canceled)

24. (canceled)

25. The container system of claim 17, wherein the AR device includes AR glasses, an AR headset, an AR helmet, an AR projection system, or a handheld AR device.

26. (canceled)

27. The container system of claim 17, wherein
the on-board controller is configured to receive a food product order and transmit instructions associated with the received food product order to the AR device; and
the AR device, based on the instructions received from the on-board controller, is configured to perform one or more actions including:
indicate one of the one or more food preparation and storage equipment for storage or preparation of a food item associated with the received food product order to the user in an AR vision of the re-configurable environment;
enable the user to control operation of a robotic arm to move or process the food item associated with the received food product order; or
enable the user to control an operational parameter of the one of the one or more food preparation and storage equipment for storage or preparation of the food item associated with the received food product order.

28. (canceled)

29. (canceled)

30. The container system of claim 17, wherein the container is compartmentalized to enable distinct environmental conditions for the one or more food preparation and storage equipment and compartments of the container are configured to feed each other with outputs of the one or more food preparation and storage equipment in each compartment.

31. The container system of claim 17, wherein
the travel information includes one or more delivery destination locations, one or more potential routes between the delivery destinations, road condition information for the potential routes, traffic condition information for the potential routes, or weather condition information for the potential routes;
the food items information includes one or more of quantity information, quality information, or type information associated with ingredients for a food product to be prepared; and
the food product information includes one or more of quantity information, quality information, type information, or packaging information associated with the food product to be prepared.

32. A method for preparation of food items en route, the method comprising:
providing a re-configurable environment for one or more food preparation and storage equipment with robotic devices to prepare food items en route to a delivery destination in a container portion of a vehicle;
providing wired or wireless communications with a remote controller system through an on-board communication system;
receiving, at an on-board controller communicatively coupled to the on-board communication system, instructions from the remote controller system associated with one or more steps and a timing for a process to prepare the food items based on travel information, food items information, and food product information collected by the remote controller system for the vehicle; and
providing an augmented reality (AR) view of the re-configurable environment to enable a user to control operations of the robotic devices for the preparation of the food items or to provide instructions to the user associated with the preparation of the food items through an AR device communicatively coupled to the on-board controller.

33. The method of claim 32, further comprising one or more of:
indicating through the AR device one of the one or more food preparation and storage equipment for storage or preparation of a food item associated with a received food product order to the user in an AR vision of the re-configurable environment;
prompting the user through the AR device to one of: move the food item to another of the one or more food preparation and storage equipment, move the food item into a food delivery packaging, remove the food item from the one of the one or more food preparation and storage equipment, or place a new food item into the one of the one or more food preparation and storage equipment through the AR vision of the re-configurable environment;
providing the user with control of an operation of a robotic arm to move or process a food item associated with a received food product order through the AR device;
providing the user with control of an operational parameter of one of the one or more food preparation and storage equipment for storage or preparation of a food item associated with a received food product order through the AR device, wherein the operational parameter is one or more of a heating temperature, a cooling temperature, a storage temperature, a food item processing step, a timing for the food item processing step.

34. (canceled)

35. (canceled)

36. (canceled)

37. (canceled)

38. (canceled)

39. (canceled)

40. The method of claim 32, further comprising:
receiving a food product order at the on-board controller and transmitting instructions associated with the received food product order from the on-board controller to the AR device; and
in response to the instructions received from the on-board controller, performing one or more actions at the AR device including:
indicating one of the one or more food preparation and storage equipment for storage or preparation of a food item associated with the received food product order to the user in an AR vision of the re-configurable environment;
providing the user with control of an operation of a robotic arm to move or process the food item associated with the received food product order; or
providing the user with control of an operational parameter of the one of the one or more food preparation and storage equipment for storage or preparation of the food item associated with the received food product order.

41. The method of claim 40, further comprising:
receiving an update to the received food product order at the on-board controller and transmitting instructions associated with the updated food product order from the on-board controller to the AR device; and
in response to the instructions received from the on-board controller, performing one or more modified actions at the AR device based on the updated food product order.

42. The method of claim 41, further comprising:
receiving the food product order and the update to the received food product order prior to a departure of the vehicle from a starting point or waypoint,
receiving the food product order prior to the departure of the vehicle from the starting point or waypoint and receiving the update to the received food product order while the vehicle is en route, or
receiving the food product order and the update to the received food product order while the vehicle is en route.

43. (canceled)
